(19) United States
(12) Patent Application Publication
(10) Pub. No.: US 2006/0089431 A1
(43) Pub. Date: Apr. 27, 2006

(54) Curable composition

(75) Inventors: Atsushi Kawakami, Takasago-shi (JP); Katsuhiro Ando, Akashi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka (JP)

(21) Appl. No.: 11/255,863

(22) Filed: Oct. 24, 2005

Related U.S. Application Data
(60) Provisional application No. 60/628,955, filed on Nov. 19, 2004.

(30) Foreign Application Priority Data
Oct. 25, 2004 (JP) 2004-310131

(51) Int. Cl. C08L 95/00; C08L 83/00; B32B 11/00

(52) U.S. Cl. 524/59; 524/588

(57) ABSTRACT

A solventless cold-setting curable composition includes a bituminous substance (A) and a vinyl polymer (B) which has a reactive silicon group capable of being crosslinked by forming a siloxane bond by a silanol condensation reaction and whose main chain is produced by living radical polymerization.

### BACKGROUND OF THE INVENTION

1. Field of the Invention

The present invention relates to a curable composition including a bituminous substance and a vinyl polymer which has a reactive silicon group and whose main chain is produced by living radical polymerization. The present invention also relates to an adhesive for tiles, a waterproof material, a road-paving material, a water-stopping material for civil engineering, and a damping material.

2. Description of the Related Art

Bituminous substances such as asphalt are widely used as a convenient material in many fields such as a road-paving material, a roofing material, a sealing material, an adhesive, a waterway lining material, a damping material, and a soundproof material because such substances are excellent in tackiness, workability, and water-proofing property and are inexpensive.

Hitherto, for example, when asphalt is used for a roofing material, a hot process for asphalt waterproofing, in which a plurality of asphalt layers are laminated to form a waterproofing layer, has been actively employed as the mainstream of waterproofing works. Although the hot process provides satisfactorily high waterproofing reliability, when asphalt is melted, the molten asphalt generates a large amount of fume and odor, resulting in significant pollution of the surrounding environment. Thus, the hot process has been avoided in thickly housed areas and central urban areas, and the area that can use the hot process has been limited. Furthermore, since workers face dangers of burn injury, they also tend to avoid the hot process.

In order to overcome these problems, a self-adhesion process, which is one of cold processes, has been developed and gaining popularity in this field. However, in this process, a large number of sheets of paper released during the working must be discarded. The disposal of the released paper causes a serious problem.

In addition, in view of the performance, blown asphalt prepared by air blowing is generally used as a roofing material. However, the blown asphalt is generally brittle because of its hardness and breaking of materials due to ambient temperature, and easily cracks at low temperature. On the other hand, asphalt having satisfactory low temperature properties may exhibit unacceptable fluidity or deformation during the summer. To overcome this problem, an epoxy resin-asphalt system and the like have been developed. Consequently, rutting resistance in the summer has been improved by imparting strength to the asphalt. However, the problem of cracking in the winter has not been solved yet.

Recently, in order to improve the occurrence of cracks, trials of adding a rubber modifier such as natural rubber, styrene-butadiene rubber, or chloroprene rubber to provide elasticity have been performed (for example, see Japanese Unexamined Patent Application Publication No. 10-279808). However, since these rubber modifiers have low compatibility with asphalt, it is difficult to produce a homogeneous composition. Therefore, stirring under heating at a high temperature must be performed for a long time during dispersion, and thus the modification of asphalt due to the rubber modifier may be insufficient. As a result, adhesiveness to base materials becomes insufficient and the waterproof and water stopping performances are not satisfied.

### SUMMARY OF THE INVENTION

Accordingly, it is an object of the present invention to provide a solventless cold-setting asphalt composition that produces neither a fume nor an odor during working and causes no volatilization of a solvent.

In order to solve the above-described problems, the inventors of the present invention have conducted intensive research and consequently found that a curable composition that can solve the above problems is produced by adding a vinyl polymer which has a reactive silicon group and whose main chain is produced by living radical polymerization to a bituminous substance. As a result, the present invention has been made.

Specifically, the present invention provides the following (1) to (23):

(1) A curable composition including a bituminous substance (A) and a vinyl polymer (B) which has a reactive silicon group represented by general formula (1):
—Si (R¹₃₋ₐ)Yₐ (1)
(wherein R¹ represents an alkyl group having 1 to 20 carbon atoms, an aryl group having 6 to 20 carbon atoms, an aralkyl group having 7 to 20 carbon atoms, or a triorganosiloxy group represented by (R′O)₃Si— (wherein R′ represents a monovalent hydrocarbon group having 1 to 20 carbon atoms and the three R′s may be the same or different), and when two R¹s are present, they may be the same or different; Y represents a hydroxyl group or a hydrolyzable group, and when two or more Ys are present, they may be the same or different; and a represents 1, 2, or 3) and whose main chain is produced by living radical polymerization;

(2) The curable composition described in (1) above, wherein the main chain of the vinyl polymer (B) is produced by polymerizing mainly at least one monomer selected from the group consisting of (meth)acrylic monomers, acrylonitrile monomers, aromatic vinyl monomers, fluorine-containing vinyl monomers, and silicon-containing vinyl monomers;

(3) The curable composition described in (1) or (2) above, wherein the main chain of the vinyl polymer (B) is a (meth)acrylic polymer;

(4) The curable composition described in any one of (1) to (3) above, wherein the main chain of the vinyl polymer (B) is an acrylic polymer;

(5) The curable composition described in (4) above, wherein the main chain of the vinyl polymer (B) is an acrylate polymer;

(6) The curable composition described in any one of (1) to (5) above, wherein the main chain of the vinyl polymer (B) is produced by atom transfer radical polymerization;

(7) The curable composition described in (6) above, wherein, in the atom transfer radical polymerization, a complex selected from transition metal complexes containing, as a central metal, an element selected from Group 7, Group 8, Group 9, Group 10, and Group 11 in the periodic table is used as a catalyst;

(8) The curable composition described in (7) above, wherein the complex used as the catalyst is a complex selected from the group consisting of complexes of copper, nickel, ruthenium, or iron;

(9) The curable composition described in any one of (1) to (8) above, further including a plasticizer (c);

(10) The curable composition described in (9) above, wherein the plasticizer (c) is an aromatic oligomer or a completely or partially hydrogenated product of an aromatic oligomer;

(11) The curable composition described in (9) above, wherein the plasticizer (c) is a sulfonic ester compound or a sulfonamide compound;

(12) The curable composition described in any one of (1) to (11) above, further including an epoxy resin (D);

(13) The curable composition described in (12) above, wherein the content of the epoxy resin (D) is 5 to 120 parts by weight relative to 100 parts by weight of the bituminous substance (A);

(14) The curable composition described in any one of (1) to (13) above, further including an alkyl (meth)acrylate polymer (E);

(15) The curable composition described in (14) above, wherein the molecular chain of the alkyl (meth)acrylate polymer (E) is a copolymer including an alkyl (meth)acrylate monomer unit (a) containing an alkyl group having 1 to 8 carbon atoms and an alkyl (meth)acrylate monomer unit (b) containing an alkyl group having at least 10 carbon atoms;

(16) The curable composition described in any one of (1) to (15) above, further including a tackifier (F);

(17) The curable composition described in (16) above, wherein the tackifier (F) is a tackifying resin modified with at least one of phenol and an alkyl phenol;

(18) The curable composition described in any one of (1) to (17) above, wherein the bituminous substance (A) includes at least one of natural asphalt and petroleum asphalt;

(19) An adhesive for tiles, including the curable composition described in any one of (1) to (18) above;

(20) A waterproof material including the curable composition described in any one of (1) to (18) above;

(21) A road-paving material including the curable composition described in any one of (1) to (18) above;

(22) A water-stopping material for civil engineering, the water-stopping material including the curable composition described in any one of (1) to (18) above; and

(23) A damping material including the curable composition described in any one of (1) to (18) above.

The use of the curable composition of the present invention can provide a curable composition having excellent water resistance, curability, and storage stability, and that need not be heat-melted during working and produces neither a fume nor an odor.

### DESCRIPTION OF THE PREFERRED EMBODIMENTS

Examples of a bituminous substance (A) of the present invention include natural asphalt such as lake asphalt, e.g., Trinidad epure, gilsonite, and pyrobitumen, and rock asphalt, and cutback asphalt of these; petroleum asphalt and petroleum pitch such as straight asphalt and blown asphalt, which are produced by a petroleum refining process, and cutback asphalt of these; mixed bituminous substances such as pitch bitumen and astar; and petroleum process oil such as cycle oil from heavy oil catalytic cracking, cycle oil from light oil catalytic cracking, lubricating oil, distillation fraction of these oils or other distillation faction subjected to treatment such as extraction, refining, hydrogenation, or the like. The bituminous substance (A) may be a mixture of at least two of the above substances. In particular, straight asphalt produced by a petroleum refining process is more preferable from the viewpoint that compatibility with the component (B) and stable dispersibility can be obtained.

The vinyl polymer (B) of the present invention, i.e., the vinyl polymer which has a reactive silicon group and whose main chain is produced by living radical polymerization, can be produced by the following methods.

<<Vinyl Polymer (B) Whose Main Chain is Produced by Living Radical Polymerization>>

<Main Chain>

A vinyl monomer constituting the main chain of the vinyl polymer (B) of the present invention is not particularly limited and various monomers can be used. Examples of the vinyl monomer include (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl) trimethoxysilane, ethylene oxide adducts of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate; aromatic vinyl monomers such as styrene, vinyltoluene, α-methylstyrene, chlorostyrene, styrenesulfonic acid, and salts thereof; fluorine-containing vinyl monomers such as perfluoroethylene, perfluoropropylene, and vinylidene fluoride; silicon-containing vinyl monomers such as vinyltrimethoxysilane and vinyltriethoxysilane; maleic anhydride, maleic acid, monoalkyl maleate, and dialkyl maleate; fumaric acid, monoalkyl fumarate, and dialkyl fumarate; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide; acrylonitrile monomers such as acrylonitrile and methacrylonitrile; amido group-containing vinyl monomers such as acrylamide and methacrylamide; vinyl esters such as vinyl acetate, vinyl propionate, vinyl pivalate, vinyl benzoate, and vinyl cinnamate; alkenes such as ethylene and propylene; conjugated dienes such as butadiene and isoprene; vinyl chloride, vinylidene chloride, allyl chloride, and allyl alcohol. These monomers may be used alone or a plurality of these monomers may be copolymerized.

The main chain of the vinyl polymer (B) is preferably produced by polymerizing mainly at least one monomer selected from the group consisting of (meth)acrylic monomers, acrylonitrile monomers, aromatic vinyl monomers, fluorine-containing vinyl monomers, and silicon-containing vinyl monomers. Herein, the term “mainly” means that the content of the above monomer is 50 mole percent or more, preferably 70 mole percent or more of the monomer unit constituting the vinyl polymer (B).

Among these, in view of physical properties of a product or the like, styrene monomers and (meth)acrylic monomers are preferred, acrylate monomers and methacrylate monomers are more preferred, acrylate monomers are particularly preferred, and butyl acrylate is further preferred. In the present invention, these preferable monomers may be copolymerized with other monomers, furthermore, may be block-copolymerized with other monomers. In such a case, the content of the preferable monomers is preferably 40 percent by weight or more. In the above expression, for example, “(meth)acrylic acid” represents acrylic acid and/or methacrylic acid.

Additionally, for an application requiring rubber elasticity, the glass transition temperature of the vinyl polymer is preferably room temperature or a temperature lower than the use temperature, but is not limited to this.

The molecular weight distribution of the vinyl polymer (B), that is, the ratio (Mw/Mn) of the weight-average molecular weight (Mw) to the number-average molecular weight (Mn) measured by gel permeation chromatography, is not particularly limited. The molecular weight distribution of the vinyl polymer (B) is preferably less than 1.8, more preferably 1.6 or less, and particularly preferably 1.3 or less. In the GPC measurement in the present invention, in general, chloroform is used as a mobile phase and a polystyrene gel column is used for the measurement. The number-average molecular weight and the like can be determined on the polystyrene equivalent basis.

The number-average molecular weight of the vinyl polymer (B) in the present invention is not particularly limited. However, the number-average molecular weight is preferably in a range of 500 to 1,000,000, more preferably, 5,000 to 50,000 when measured by gel permeation chromatography.

<Method of Synthesizing Main Chain>

A method for synthesizing the vinyl polymer (B) in the present invention is limited to living radical polymerization among controlled radical polymerization methods, and atom transfer radical polymerization is preferable. These methods will be described below.

Controlled Radical Polymerization

Radical polymerization methods are classified into the “ordinary radical polymerization method (free radical polymerization method)” in which a monomer having a specific functional group and a vinyl monomer are merely copolymerized using a polymerization initiator such as an azo compound, a peroxide, or the like, and the “controlled radical polymerization method” in which a specific functional group can be introduced into a controlled site such as a terminus.

The “ordinary radical polymerization method” is simple and easy to perform. In the method, however, a monomer having a specific functional group is introduced into the polymer only at random. This method is disadvantageous in that, in order to produce a polymer with a high functionality, a considerable amount of this monomer must be used, and conversely, when only a small amount of the monomer is used, the ratio of a polymer in which this specific functional group is not introduced increases. Furthermore, since the method belongs to free radical polymerization, only polymers having a wide molecular weight distribution and a high viscosity are produced.

The “controlled radical polymerization method” can be further classified into the “chain transfer agent method” in which polymerization is performed using a chain transfer agent having a specific functional group to provide functional group-terminated vinyl polymers and the “living radical polymerization method” in which growing polymerization termini can grow without undergoing termination reactions and the like to provide polymers having a molecular weight approximately as designed.

Although the “chain transfer agent method” can provide polymers having high functionality, the method requires a considerable amount of a chain transfer agent having a specific functional group relative to an initiator. Therefore, the “chain transfer agent method” has economical problems including treatment cost. As in the “ordinary radical polymerization method”, only polymers having a wide molecular weight distribution and a high viscosity are produced because the chain transfer agent method also belongs to free radical polymerization.

Unlike these polymerization methods, the “living radical polymerization method” hardly undergoes termination reactions and can provide polymers having a narrow molecular weight distribution (Mw/Mn of about 1.1 to about 1.5) and allow the molecular weight to be arbitrarily controlled by changing the charging ratio between a monomer and an initiator, although the living radical polymerization method belongs to radical polymerization, which is generally regarded as difficult to control because the rate of polymerization is high and termination reactions due to, for example, coupling between radicals easily occur.

The “living radical polymerization method” can provide polymers having a narrow molecular weight distribution and a low viscosity and, in addition, allow monomers having a specific functional group to introduce into almost arbitrary positions of the polymers. Therefore, the living radical polymerization method is more preferable as the method for producing the vinyl polymers having a specific functional group.

The term “living polymerization”, in its narrow sense, means polymerization in which molecular chains grow while maintaining activity at their termini. In general, however, the living polymerization also includes pseudo-living polymerization in which molecular chains grow in equilibrium between inactivated termini and activated termini. The latter definition applies to the present invention.

Recently, the “living radical polymerization method” has actively been studied by a large number of groups. Examples of the studies include a study using a cobalt porphyrin complex, as described in the Journal of the American Chemical Society (J. Am. Chem. Soc.), 1994, Vol. 116, p. 7943, a study using a radical scavenger such as a nitroxide compound, as described in Macromolecules, 1994, Vol. 27, p. 7228, and “atom transfer radical polymerization” (ATRP) using an organic halide or the like as an initiator and a transition metal complex as a catalyst.

Among the “living radical polymerization methods”, the “atom transfer radical polymerization method”, in which a vinyl monomer is polymerized using an organic halide, a halogenated sulfonyl compound, or the like as an initiator and a transition metal complex as a catalyst, is more preferable for the method for producing vinyl polymers having a specific functional group. This is because this method not only has the features of the “living radical polymerization” but also provides polymers having a terminal halogen atom that is relatively advantageous to functional group conversion reactions and, in addition, an initiator and a catalyst can be designed with a high degree of freedom. Examples of this atom transfer radical polymerization are described by Matyjaszewski et al., Journal of the American Chemical Society (J. Am. Chem. Soc.) 1995, Vol. 117, p. 5614; Macromolecules 1995, Vol. 28, p. 7901; Science 1996, Vol. 272, p. 866; PCT Publication Nos. WO96/30421, WO97/18247, WO98/01480, and WO98/40415; and by Sawamoto et al., Macromolecules 1995, Vol. 28, p. 1721; and Japanese Unexamined Patent Application Publication Nos. 9-208616 and 8-41117.

In the present invention, which of the above living radical polymerization methods is to be employed is not particularly limited, but the atom transfer radical polymerization is preferable.

The living radical polymerization will be described in detail below. Prior thereto, polymerization using a chain transfer agent, which is one of controlled radical polymerization methods usable for producing the vinyl polymer described below, is described. The radical polymerization using a chain transfer agent (telomer) is not particularly limited but exemplified by the following two methods for producing vinyl polymers having a terminal structure suitable for the present invention.

The methods includes a method for producing halogen-terminated polymers using a halogenated hydrocarbon as a chain transfer agent, as described in Japanese Unexamined Patent Application Publication No. 4-132706 and a method of producing hydroxyl-terminated polymers using a hydroxyl-containing mercaptan or a hydroxyl-containing polysulfide or the like as a chain transfer agent, as described in Japanese Unexamined Patent Application Publication No. 61-271306, Japanese Patent No. 2594402, or Japanese Unexamined Patent Application Publication No. 54-47782.

The living radical polymerization will now be described.

First, the method using a radical scavenger such as a nitroxide compound will be described. In this polymerization, a nitroxy free radial (═N—O.), which is generally stable, is used as a radical capping agent. Preferred examples of such a compound include, but are not limited to, cyclic hydroxyamine-derived nitroxy free radicals such as 2,2,6,6-substituted-1-piperidinyloxy radicals and 2,2,5,5-substituted-1-piperidinyloxy radicals. The substituents are preferably alkyl groups having 4 or less of carbon atoms such as methyl group and ethyl group. Specific examples of nitroxy free radical compounds include, but are not limited to, 2,2,6,6-tetramethyl-1-piperidinyloxy radical (TEMPO), 2,2,6,6-tetraethyl-1-piperidinyloxy radical, 2,2,6,6-tetramethyl-4-oxo-1-piperidinyloxy radical, 2,2,5,5-tetramethyl-1-pyrrolidinyloxy radical, 1,1,3,3-tetramethyl-2-isoindolinyloxy radical, and N,N-di-tert-butylaminoxy radical. Other stable free radicals such as galvinoxyl free radical may also be used instead of nitroxy free radicals.

The above radical capping agent is used in combination with a radical generator. It is believed that a reaction product produced from a radical capping agent and a radical generator functions as a polymerization initiator to allow the polymerization of an addition-polymerizable monomer to proceed. Although the ratio between both is not particularly limited, the radical initiator is used appropriately in an amount of 0.1 to 10 moles per mole of the radical capping agent.

Various compounds can be used as the radical generator, but peroxides capable of generating a radical under a polymerization temperature condition are preferable. Examples of such peroxides include, but are not limited to, diacyl peroxides such as benzoyl peroxide and lauroyl peroxide; dialkyl peroxides such as dicumyl peroxide and di-tert-butyl peroxide; peroxycarbonates such as diisopropyl peroxydicarbonate and bis(4-tert-butylcyclohexyl) peroxydicarbonate; and alkyl peresters such as tert-butyl peroxyoctoate and tert-butyl peroxybenzoate. In particular, benzoyl peroxide is preferable. Furthermore, other radical generators such as radical-generating azo compounds, e.g., azobisisobutyronitrile, can also be used instead of peroxides.

Alkoxyamine compounds such as those illustrated below may be used as initiators instead of combination of a radical capping agent and a radical generator, as reported in Macromolecules, 1995, Vol. 28, p. 2993.

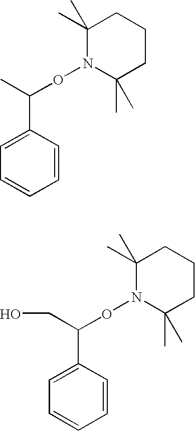

When the alkoxyamine compound used as an initiator is one having a functional group such as a hydroxyl group, as illustrated above, functional group-terminated polymers are obtained. When this method is applied to the present invention, functional group-terminated polymers can be obtained.

The polymerization conditions including the monomer, solvent, and polymerization temperature used in the above polymerization using a radical scavenger such as a nitroxide compound are not particularly limited, but may be the same as those used in the atom transfer radical polymerization described below.

Atom Transfer Radical Polymerization

The atom transfer radical polymerization method, which is more preferable as the living radical polymerization in the present invention, will now be described.

In this atom transfer radical polymerization, an organic halide, in particular, an organic halide having a highly reactive carbon-halogen bond (e.g. a carbonyl compound having a halogen at an α-position or a compound having a halogen at a benzyl position), a halogenated sulfonyl compound, or the like is used as an initiator.

Specific examples of the compounds include

C₆H₅—CH₂X, C₆H₅—C(H)(X)CH₃ and C₆H₅—C(X)(CH₃)₂

(in the above chemical formulae, C₆H₅ represents a phenyl group and X represents a chlorine, bromine, or iodine atom);

R²—C(H) (X)—CO₂R³, R²—C(CH₃)(X)—CO₂R³, R²—C(H)(X)—C(O)R³, and R²—C(CH₃)(X)—C(O)R³

(wherein each of R² and R³ represents a hydrogen atom or an alkyl, aryl, or aralkyl group having 1 to 20 carbon atoms and X represents a chlorine, bromine, or iodine atom); and

R²—C₆H₄—SO₂X

(wherein R² represents a hydrogen atom or an alkyl, aryl, or aralkyl group having 1 to 20 carbon atoms and X represents a chlorine, bromine, or iodine atom).

An organic halide or halogenated sulfonyl compound further having a functional group in addition to the functional group for initiating the polymerization may also be used as the initiator in the atom transfer radical polymerization. In such a case, vinyl polymers having the functional group at one of the main chain termini and a growing terminal structure of atom transfer radical polymerization at the other main chain terminus are produced. Examples of such a functional group include alkenyl, crosslinkable silyl, hydroxyl, epoxy, amino, and amido groups.

The organic halide having an alkenyl group is not particularly limited. Examples of the organic halide having an alkenyl group include compounds having a structure represented by general formula (2):
R⁵R⁶C(X)—R⁷—R⁸—C(R⁴)═CH₂ (2)
(wherein R⁴ represents a hydrogen atom or a methyl group, each of R⁵ and R⁶ represents a hydrogen atom or a monovalent alkyl, aryl, or aralkyl group having 1 to 20 carbon atoms and such R⁵ and R⁶ may be connected to each other at the respective other ends, R⁷ represents —C(O)O— (ester group), —C(O)— (keto group), or an o-, m-, or p-phenylene group, R⁸ represents a direct bond or a divalent organic group having 1 to 20 carbon atoms, which may include at least one ether bond, and X represents a chlorine, bromine, or iodine atom).

Specific examples of the substituents R⁵ and R⁶ include a hydrogen atom, methyl, ethyl, n-propyl, isopropyl, butyl, pentyl, and hexyl groups. R⁵ and R⁶ may be connected to each other at the respective other ends to form a cyclic skeleton.

Specific examples of the organic halide represented by general formula (2), the organic halide having an alkenyl group, include
XCH₂C(O)O(CH₂)ₙCH═CH₂, H₃CC(H)(X)C(O)O(CH₂)ₙCH═CH₂, (H₃C)₂C(X)C(O)O(CH₂)ₙCH═CH₂, CH₃CH₂C(H)(X)C(O)O(CH₂)ₙCH═CH₂, and 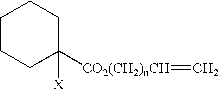
(in the above formulae, X represents a chlorine, bromine, or iodine atom and n represents an integer of 0 to 20);
XCH₂C(O)O(CH₂)ₙO(CH₂)ₘCH═CH₂, H₃CC(H)(X)C(O)O(CH₂)ₙO(CH₂)ₘCH═CH₂, (H₃C)₂C(X)C(O)O(CH₂)ₙO(CH₂)ₘCH═CH₂, CH₃CH₂C(H)(X)C(O)O(CH₂)ₙO(CH₂)ₘCH═CH₂, and 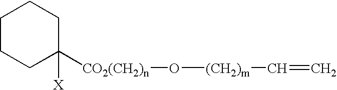
(in the above formulae, X represents a chlorine, bromine, or iodine atom, n represents an integer of 0 to 20, and m represents an integer of 1 to 20);
o-, m-, p-XCH₂—C₆H₄—(CH₂)—CH═CH₂; o-, m-, p-CH₃C(H)(X)—C₆H₄—(CH₂)ₙ—CH═CH₂; and o-, m-, p-CH₃CH₂C(H)(X)—C₆H₄—(CH₂)ₙ—CH═CH₂
(in the above formulae, X represents a chlorine, bromine, or iodine atom and n represents an integer of 0 to 20);
o-, m-, p-XCH₂—C₆H₄—(CH₂)ₙ—O—(CH₂)ₘ—CH═CH₂; o-, m-, p-CH₃C(H)(X)—C₆H₄—(CH₂)ₙ—O—(CH₂)ₘ—CH═CH₂; and o-, m-, p-CH₃CH₂C(H) (X)—C₆H₄—(CH₂)ₙ—O— (CH₂)ₘCH═CH₂
(in the above formulae, X represents a chlorine, bromine, or iodine atom, n represents an integer of 0 to 20, and m represents an integer of 1 to 20);
o-, m-, p-XCH₂—C₆H₄—O—(CH₂)ₙ—CH═CH₂; o-, m-, p-CH₃C(H)(X)—C₆H₄—O—(CH₂)ₙ—CH═CH₂; and o-, m-, p-CH₃CH₂C(H)(X)—C₆H₄—O—(CH₂)ₙ—CH═CH₂
(in the above formulae, X is a chlorine, bromine, or iodine atom and n represents an integer of 0 to 20);
o-, m-, p-XCH₂—C₆H₄—O—(CH₂)ₙ—O—(CH₂)ₘ—CH═CH₂; o-, m-, p-CH₃C(H)(X)—C₆H₄—O—(CH₂)ₙ—O—(CH₂)ₘ—CH═CH₂; and o-, m-, p-CH₃CH₂C(H)(X)—C₆H₄—O—(CH₂)ₙ—O—(CH₂)ₘ—CH═CH₂
(in the above formulae, X represents a chlorine, bromine, or iodine atom, n represents an integer of 0 to 20, and m represents an integer of 1 to 20).

Other examples of the organic halide having an alkenyl group include compounds represented by general formula (3):
H₂C═C(R⁴)—R⁸—C(R⁵)(X)—R⁹—R⁶ (3)
(wherein R⁴, R⁵, R⁶, R⁸, and X represent the same as the above and R⁹ represents a direct bond, —C(O)O— (ester group), —C(O)— (keto group), or an o-, m-, or p-phenylene group).

R represents a direct bond or a divalent organic group (which may include at least one ether bond) having 1 to 20 carbon atoms. When R⁸ is a direct bond, a vinyl group is bound to the carbon atom to which a halogen is bound, thus forming an allyl halide compound. In this case, since the carbon-halogen bond is activated by the adjacent vinyl group, R⁹ is not always required to be a C(O)O group, a phenylene group, or the like, but may be a direct bond. When R⁸ is not a direct bond, R⁹ is preferably a C(O)O, C(O), or phenylene group so that the carbon-halogen bond is activated.

Specific examples of the compounds represented by general formula (3) include

CH₂═CHCH₂X, CH₂═C(CH₃)CH₂X, CH₂═CHC(H)(X) CH₃, CH₂═C(CH₃)C(H)(X)CH₃, CH₂═CHC(X)(CH₃)₂, CH₂═CHC(H)(X)C₂H₅, CH₂═CHC(H)(X)CH(CH₃)₂, CH₂═CHC(H)(X)C₆H₅, CH₂═CHC(H)(X)CH₂C₆H₅, CH₂═CHCH₂C(H)(X)—CO₂R¹⁰, CH₂═CH(CH₂)₂C(H)(X)—CO₂R¹⁰, CH₂═CH(CH₂)₃C(H)(X)—CO₂R¹⁰, CH₂═CH(CH₂)₈C(H)(X)—CO₂R¹⁰, CH₂═CHCH₂C(H)(X)—C₆H₅, CH₂═CH(CH₂)₂C(H)(X)—C₆H₅, and CH₂═CH(CH₂)₃C(H)(X)—C₆H₅

(in the above formulae, X represents a chlorine, bromine, or iodine atom and R¹⁰ represents an alkyl, aryl, or aralkyl group having 1 to 20 carbon atoms).

Specific examples of the halogenated sulfonyl compound having an alkenyl group include

o-, m-, p-CH₂═CH—(CH₂)—C₆H₄—SO₂X and o-, m-, p-CH₂═CH—(CH₂)—O—C₆H₄—SO₂X

(in the above formulae, X represents a chlorine, bromine, or iodine atom and n represents an integer of 0 to 20).

The above organic halide having a crosslinkable silyl group is not particularly limited. Examples of the organic halide having a crosslinkable silyl group include compounds having a structure represented by general formula (4):
R⁵R⁶C(X)—R⁷—R⁸—C(H)(R⁴)CH₂—Si(R¹)₃₋ₐ(y)ₐ (4)
(wherein R⁴, R⁵, R⁶, R⁷, R⁸, and X represent the same as the above; R¹ represents an alkyl, aryl, or aralkyl group having 1 to 20 carbon atoms or a triorganosiloxy group represented by (R′)₃SiO— (wherein R′ is a monovalent hydrocarbon group having 1 to 20 carbon atoms and the three R′s may be the same or different), and when two or more R′s are present, they may be the same or different; Y represents a hydroxyl group or a hydrolyzable group, and when two or more Ys are present, they may be the same or different; and a represents 1, 2, or 3).

Specific examples of the compounds represented by general formula (4) include

XCH₂C(O)O(CH₂)ₙSi(OCH₃)₃, CH₃C(H)(X)C(O)O(CH₂)ₙSi(OCH₃)₃, (CH₃)₂C(X)C(O)O(CH₂)ₙSi(OCH₃)₃, XCH₂C(O)O(CH₂)ₙSi(CH₃)(OCH₃)₂, CH₃C(H)(X)C(O)O(CH₂)ₙSi(CH₃)(OCH₃)₂, and (CH₃)₂C(X)C(O)O(CH₂)ₙSi(CH₃)(OCH₃)₂

(in the above formulae, X represents a chlorine, bromine, or iodine atom and n represents an integer of 0 to 20);

XCH₂C(O)O(CH₂)ₙO(CH₂)ₘSi(OCH₃)₃, H₃CC(H)(X)C(O)O(CH₂)ₙO(CH₂)ₘSi(OCH₃)₃, (H₃C)₂C(X)C(O)O(CH₂)ₙO(CH₂)ₘSi(OCH₃)₃, CH₃CH₂C(H)(X)C(O)O(CH₂)ₙO(CH₂)ₘSi(OCH₃)₃, XCH₂C(O)O(CH₂)ₙO(CH₂)ₘSi(CH₃)(OCH₃)₂, H₃CC(H)(X)C(O)O(CH₂)ₙO(CH₂)ₘ—Si(CH₃)(OCH₃)₂, (H₃C)₂C(X)C(O)O(CH₂)ₙO(CH₂)ₘ—Si(CH₃) (OCH₃)₂, and CH₃CH₂C(H)(X)C(O)O(CH₂)ₙO(CH₂)ₘ—Si(CH₃)(OCH₃)₂

(in the above formulae, X represents a chlorine, bromine, or iodine atom, n represents an integer of 0 to 20, and m represents an integer of 1 to 20);

o-, m-, p-XCH₂—C₆H₄—(CH₂)₂Si(OCH₃)₃; o-, m-, p-CH₃C(H) (X)—C₆H₄—(CH₂)₂Si (OCH₃)₃; o-, m-, p-CH₃CH₂C(H)(X)—C₆H₄—(CH₂)₂Si(OCH₃)₃; o-, m-, p-XCH₂—C₆H₄—(CH₂)₃Si(OCH₃)₃; o-, m-, p-CH₃C(H) (X)—C₆H₄—(CH₂) ₃Si(OCH₃)₃; o-, m-, p-CH₃CH₂C(H)(X)—C₆H₄—(CH₂)₃Si(OCH₃)₃; o-, m-, p-XCH₂—C₆H₄—(CH₂)₂—O—(CH₂)₃Si(OCH₃)₃; o-, m-, p-CH₃C(H)(X)—C₆H₄—(CH₂)₂—(CH₂) ₃Si(OCH₃)₃; o-, m-, p-CH₃CH₂C(H)(X)—C₆H₄—(CH₂)₂—O—(CH₂)₃Si(OCH₃)₃; o-, m-, p-XCH₂—C₆H₄—O—(CH₂)₃Si(OCH₃)₃; o-, m-, p-CH₃C(H)(X)—C₆H₄—O—(CH₂)₃Si(OCH₃)₃; o-, m-, p-CH₃CH₂C(H)(X)—C₆H₄—O—(CH₂)₃—Si(OCH₃)₃; o-, m-, p-XCH₂—C₆H₄—O—(CH₂)₂—O—(CH₂)₃—Si (OCH₃)₃; o-, m-, p-CH₃C(H)(X)—C₆H₄—O—(CH₂)₂—O—(CH₂)₃Si(OCH₃)₃; and o-, m-, p-CH₃CH₂C(H)(X)—C₆H₄—O—(CH₂)₂—O—(CH₂)₃Si(OCH₃)₃

(in the above formulae, X represents a chlorine, bromine, or iodine atom).

Examples of the organic halide having a crosslinkable silyl group further include compounds having a structure represented by general formula (5):
(R¹)₃₋ₐ(Y)ₐSi—CH₂—C(H)(R⁴)—R⁸—C(R⁵)(X)—R⁹—R⁶ (5)
(wherein R⁴, R⁵, R⁶, R⁸, R⁹, R¹, a, X, and Y represent the same as the above).

Specific examples of such compound include

(CH₃O)₃SiCH₂CH₂C(H)(X)C₆H₅, (CH₃O)₂(CH₃)SiCH₂CH₂C(H)(X)C₆H₅, (CH₃O)₃Si(CH₂)₂C(H)(X)—CO₂R¹⁰, (CH₃)₂(CH₃)Si(CH₂)₂C(H)(X)—CO₂R¹⁰, (CH₃O)₃Si(CH₂)₃C(H)(X)—CO₂R¹⁰, (CH₃O)₂(CH₃)Si(CH₂)₃C(H)(X)—CO₂R¹⁰, (CH₃O)₃Si(CH₂)₄C(H)(X)—CO₂R¹⁰, (CH₃O)₂(CH₃)Si(CH₂)₄C(H)(X)—CO₂R¹⁰, (CH₃O)₃Si(CH₂)₉C(H)(X)—CO₂R¹⁰, (CH₃O)₂(CH₃)Si(CH₂)₉C(H)(X)—CO₂R¹⁰, (CH₃O)₃Si(CH₂)₃C(H)(X)—C₆H₅, (CH₃O)₂(CH₃)Si(CH₂)₃C(H)(X)—C₆H₅, (CH₃O)₃Si(CH₂)₄C(H)(X)—C₆H₅, and (CH₃O)₂(CH₃)Si(CH₂)₄C(H)(X)—C₆H₅

(in the above formulae, X represents a chlorine, bromine or iodine atom and R¹⁰ represents an alkyl, aryl, or aralkyl group having 1 to 20 carbon atoms).

The above organic halide having a hydroxyl group or the halogenated sulfonyl compound having a hydroxyl group is not particularly limited. Examples of such a compound include

HO—(CH₂)ₘ—OC(O)C(H)(R²)(X)

(wherein X represents a chlorine, bromine, or iodine atom, R² represents a hydrogen atom or an alkyl, aryl, or aralkyl group having 1 to 20 carbon atoms, and m represents an integer of 1 to 20).

The above organic halide having an amino group or the halogenated sulfonyl compound having an amino group is not particularly limited. Examples of such a compound include

H₂N—(CH₂)ₘ—OC(O)C(H)(R²)(X)

(wherein X represents a chlorine, bromine, or iodine atom, R² represents a hydrogen atom or an alkyl, aryl, or aralkyl group having 1 to 20 carbon atoms, and m represents an integer of 1 to 20).

The above organic halide having an epoxy group or the halogenated sulfonyl compound having an epoxy group is not particularly limited. Examples of such a compound include 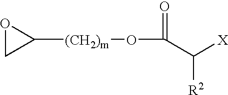
(wherein X represents a chlorine, bromine, or iodine atom, R² represents a hydrogen atom or an alkyl, aryl, or aralkyl group having 1 to 20 carbon atoms, and m represents an integer of 1 to 20).

In order to obtain polymers having at least two growing terminal structures in each molecule, an organic halide or a halogenated sulfonyl compound having at least two initiation sites is preferably used as the initiator. Specific examples of such a compound include 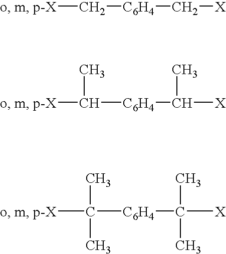
(wherein C₆H₄ represents a phenylene group and X represents a chlorine, bromine, or iodine atom) 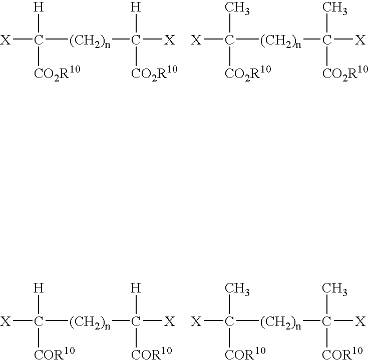
(wherein R¹⁰ represents an alkyl, aryl, or aralkyl group having 1 to 20 carbon atoms, n represents an integer of 0 to 20, and X represents a chlorine, bromine, or iodine atom) 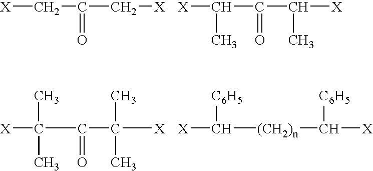
(wherein X represents a chlorine, bromine, or iodine atom and n represents an integer of 0 to 20) 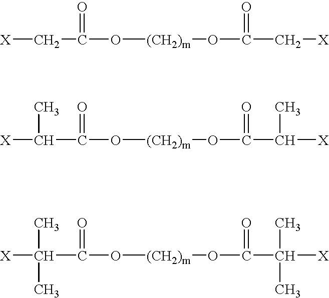
(wherein m represents an integer of 1 to 20 and X represents a chlorine, bromine, or iodine atom), and 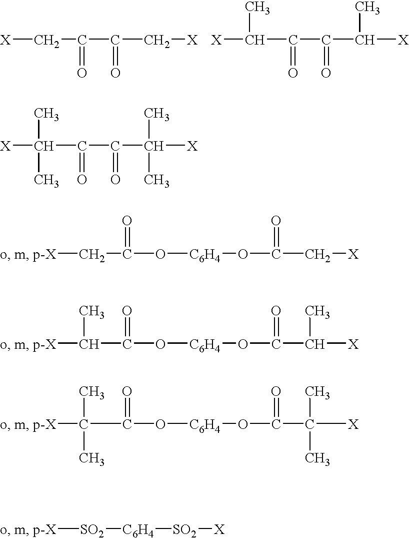
(wherein X represents a chlorine, bromine, or iodine atom).

The vinyl monomers used in this polymerization are not particularly limited and all monomers mentioned above as examples can appropriately be used.

Although the transition metal complex used as the polymerization catalyst is not particularly limited, the transition metal complex preferably includes metal complexes containing an element selected from Group 7, Group 8, Group 9, Group 10, and Group 11 in the periodic table as a central metal. More preferably, the transition metal complex includes complexes of zero-valent copper, monovalent copper, divalent ruthenium, divalent iron, or divalent nickel. Among these, a copper complex is preferable. Specific examples of the monovalent copper compound include cuprous chloride, cuprous bromide, cuprous iodide, cuprous cyanide, cuprous oxide, and cuprous perchlorate. When such a copper compound is used, a ligand, for example, 2,2′-bipyridyl or a derivative thereof, 1,10-phenanthroline or a derivative thereof, or a polyamine such as tetramethylethylenediamine, pentamethyldiethylenetriamine, or hexamethyl tris(2-aminoethyl) amine is added in order to increase the catalytic activity. Preferred ligands are nitrogen-containing compounds, more preferred ligands are chelate type nitrogen-containing compound, and still more preferred ligands are N,N,N′,N″,N″-pentamethyldiethylenetriamine. Tris triphenylphosphine complex containing divalent ruthenium chloride (RuCl₂(PPh₃)₃) is also preferable as the catalyst. When such a ruthenium compound is used as the catalyst, an aluminum alkoxide is added as an activating agent. Furthermore, bis triphenylphosphine complex containing divalent iron (FeCl₂(PPh₃)₂), bis triphenylphosphine complex containing divalent nickel (NiCl₂(PPh₃)₂), and bis tributylphosphine complex containing divalent nickel (NiBr₂(PBu₃)₂) are also suitable for the catalyst.

The polymerization may be performed in a solvent-free system or in various solvents. Examples of the solvent include hydrocarbon solvents such as benzene and toluene; ether solvents such as diethyl ether and tetrahydrofuran; halogenated hydrocarbon solvents such as methylene chloride and chloroform; ketone solvents such as acetone, methyl ethyl ketone, and methyl isobutyl ketone; alcohol solvents such as methanol, ethanol, propanol, isopropanol, n-butyl alcohol, and tert-butyl alcohol; nitrile solvents such as acetonitrile, propionitrile, and benzonitrile; ester solvents such as ethyl acetate and butyl acetate; and carbonate solvents such as ethylene carbonate and propylene carbonate. These solvents may be used alone or in combinations of two or more solvents.

Although the temperature during the polymerization is not limited, the polymerization can be generally performed in a range of 0° C. to 200° C. and preferably in a range of 50° C. to 150° C.

In the present invention, the atom transfer radical polymerization also includes the so-called reverse atom transfer radical polymerization. The reverse atom transfer radical polymerization is a method of reacting an ordinary atom transfer radical polymerization catalyst in its high oxidation state resulting from radical generation, for example, Cu (II′) when Cu (I) is used as the catalyst, with an ordinary radical initiator such as a peroxide, resulting in an equilibrium state as in atom transfer radical polymerization (see, Macromolecules, 1999, 32, p. 2872).

<Functional Group>

The Number of Crosslinkable Silyl Groups

The vinyl polymer (B) has at least one crosslinkable silyl group. In view of the curability of composition and physical properties of the cured object, the number of crosslinkable silyl groups is preferably 1.1 to 4.0, more preferably 1.2 to 3.5 on average.

Positions of Crosslinkable Silyl Group

When cured objects obtained by curing the curable composition of the present invention are particularly required to have rubber-like properties, it is preferable that at least one of the crosslinkable silyl groups is located at a molecular chain terminus so that the molecular weight between crosslinking points, which significantly influences on the rubber elasticity, can be increased. More preferably, all crosslinkable functional groups should be located at molecular chain termini.

Methods for producing the vinyl polymers (B), in particular (meth)acrylic polymers, having at least one crosslinkable silyl group at their molecular termini are disclosed in Japanese Examined Patent Application Publication Nos. 3-14068 and 4-55444, Japanese Unexamined Patent Application Publication No. 6-211922, and the like. These methods belong to the above-described free radical polymerization method using a “chain transfer agent method”. Therefore, although the resultant polymers have crosslinkable functional groups at their molecular chain termini with a relatively high ratio, the polymers generally have a value of molecular weight distribution represented by Mw/Mn as high as 2 or more, resulting in a problem that their viscosity becomes high. Accordingly, in order to produce a vinyl polymer having a narrow molecular weight distribution, a low viscosity, and crosslinkable functional groups at molecular chain termini with a high ratio, the use of the “living radical polymerization method” is preferable.

These functional groups will now be described.

Crosslinkable Silyl Group

The crosslinkable silyl groups of the vinyl polymer (B) in the present invention include groups represented by general formula (1):
—Si(R¹₃₋ₐ)Yₐ (1)
(wherein R¹ represents an alkyl group having 1 to 20 carbon atoms, an aryl group having 6 to 20 carbon atoms, an aralkyl group having 7 to 20 carbon atoms, or a triorganosiloxy group represented by (R¹⁰)₃Si— (wherein R′ represents a monovalent hydrocarbon group having 1 to 20 carbon atoms and the three R′s may be the same or different), and when two R¹s are present, they may be the same or different; Y represents a hydroxyl group or a hydrolyzable group, and when two or more Ys are present, they may be the same or different; and a represents 1, 2, or 3).

Examples of the hydrolyzable group include a hydrogen atom, alkoxy group, acyloxy group, ketoximate group, amino group, amido group, aminoxy group, mercapto group, and alkenyloxy group, which are generally used. Among these, alkoxy, amido, and aminoxy groups are preferable. In view of mild hydrolyzability and ease of handling, alkoxy groups are particularly preferable.

In view of curability, a is preferably 2 or more, but is not particularly limited. Crosslinkable silyl groups in which a is 3 (e.g. trimethoxy functional groups) are more rapid in curability than those in which a is 2 (e.g. dimethoxy functional groups). However, in some cases, crosslinkable silyl groups in which a is 2 are more excellent in storage stability or mechanical properties (such as elongation). In order to achieve a balance between curability and physical properties, a group in which a is 2 (e.g. dimethoxy functional groups) and a group in which a is 3 (e.g. trimethoxy functional groups) may be used in combination.

<Methods for Introducing Silyl Group>

Methods for introducing a silyl group into the vinyl polymer (B) of the present invention will now be described, but are not limited to the following.

Examples of a method for synthesizing the vinyl polymer (B) having at least one crosslinkable silyl group include

(A) a method of adding a hydrosilane compound having a crosslinkable silyl group to a vinyl polymer having at least one alkenyl group in the presence of a hydrosilylation catalyst;

(B) a method of reacting a vinyl polymer having at least one hydroxyl group with a compound having, in each molecule, a crosslinkable silyl group and a group capable of reacting with the hydroxyl group, such as an isocyanato group;

(C) a method of subjecting a compound having, in each molecule, a polymerizable alkenyl group and a crosslinkable silyl group to reaction in synthesizing the vinyl polymer by radical polymerization;

(D) a method of using a chain transfer agent having a crosslinkable silyl group in synthesizing the vinyl polymer by radical polymerization; and

(E) a method of reacting a vinyl polymer having at least one highly reactive carbon-halogen bond with a compound having, in each molecule, a crosslinkable silyl group and a stabilized carbanion.

The vinyl polymer having at least one alkenyl group, which is used in the above method (A), can be obtained by various methods. Several methods of synthesis will now be described, but are not limited to the following.

(A-a) A method of subjecting a compound having, in each molecule, both a polymerizable alkenyl group and a low polymerizability alkenyl group to reaction as a second monomer in synthesizing the vinyl polymer by radical polymerization, for example, the compound being represented by general formula (6):
H₂C═C(R⁴⁰)—R¹¹—R⁸—C(R¹²)═CH₂ (6)
(wherein R⁴ represents a hydrogen atom or a methyl group, R¹¹ represents —C(O)O— or an o-, m-, or p-phenylene group, R⁸ represents a direct bond or a divalent organic group having 1 to 20 carbon atoms, which may include at least one ether bond, and R¹² represents a hydrogen atom, an alkyl group having 1 to 20 carbon atoms, an aryl group having 6 to 20 carbon atoms, or an aralkyl group having 7 to 20 carbon atoms).

The timing when the compound having, in each molecule, both a polymerizable alkenyl group and a low polymerizability alkenyl group is subjected to reaction is not limited. However, in particular, when rubber-like properties are expected in living radical polymerization, the compound is preferably subjected to reaction as a second monomer at the final stage of the polymerization reaction or after completion of the reaction of the predetermined monomer.

(A-b) A method of subjecting a compound having at least two low polymerizability alkenyl groups, such as 1,5-hexadiene, 1,7-octadiene, or 1,9-decadiene, to reaction at the final stage of the polymerization or after completion of the reaction of the predetermined monomer in synthesizing the vinyl polymer by living radical polymerization.

(A-c) A method of reacting a vinyl polymer having at least one highly reactive carbon-halogen bond with an organometallic compound having an alkenyl group such as an organotin, e.g., allyltributyltin or allyltrioctyltin to substitute the halogen.

(A-d) A method of reacting a vinyl polymer having at least one highly reactive carbon-halogen bond with a stabilized carbanion having an alkenyl group to substitute the halogen, the carbanion being represented by general formula (7):
M⁺C⁻(R¹³)(R¹⁴)—R¹⁵—C(R¹²)═CH₂ (7)
(wherein R¹² represents the same as the above; both R¹³ and R¹⁴ represent electron-withdrawing groups capable of stabilizing the carbanion C⁻, or one of R¹³ and R¹⁴ represents such an electron-withdrawing group and the other represents a hydrogen atom, an alkyl group having 1 to 10 carbon atoms, or a phenyl group; R¹⁵ represents a direct bond or a divalent organic group having 1 to 10 carbon atoms, which may include at least one ether bond; and M⁺ represents an alkali metal ion or a quaternary ammonium ion).

Examples of the electron-withdrawing group R¹³ and/or R¹⁴ particularly preferably include groups having a structure of —CO₂R, —C(O)R, or —CN.

(A-e) A method of reacting a vinyl polymer having at least one highly reactive carbon-halogen bond with a metal element, such as zinc, or an organometallic compound to prepare an enolate anion, and then reacting the enolate anion with an electrophilic compound having an alkenyl group, for example, an alkenyl-containing compound having a leaving group such as a halogen atom or an acetyl group, an alkenyl-containing carbonyl compound, an alkenyl-containing isocyanate compound, or an alkenyl-containing acid halide.

(A-f) A method of reacting a vinyl polymer having at least one highly reactive carbon-halogen bond with an oxyanion having an alkenyl group or a carboxylate anion having an alkenyl group to substitute the halogen, for example, the oxyanion being represented by general formula (8):
H₂C═C(R¹²)—R¹⁶—O⁻M⁺ (8)
(wherein R¹² and M⁺ represent the same as the above and R¹⁶ represents a divalent organic group having 1 to 20 carbon atoms, which may include at least one ether bond), or the carboxylate anion being represented by general formula (9):
H₂C═C(R¹²)—R⁸—C(O)O⁻M⁺ (9)
(wherein R¹² and M⁺ represent the same as the above and R⁸ represents a direct bond or a divalent organic group having 1 to 20 carbon atoms, which may include at least one ether bond).

The method for synthesizing the above vinyl polymer having at least one highly reactive carbon-halogen bond includes, but is not limited to, atom transfer radical polymerization method using an organic halide or the like as an initiator and a transition metal complex as a catalyst, as described above.

Also, the vinyl polymer having at least one alkenyl group can be produced from a vinyl polymer having at least one hydroxyl group. Examples of the usable method will be described below, but are not limited to the following.

(A-g) A method of treating the hydroxyl group of a vinyl polymer having at least one hydroxyl group with a base, such as sodium methoxide, and reacting the product with a halide having an alkenyl group, such as allyl chloride.

(A-h) A method of reacting such a hydroxyl group with an isocyanate compound having an alkenyl group, such as allyl isocyanate.

(A-i) A method of reacting such a hydroxyl group with an acid halide having an alkenyl group, such as (meth) acrylic acid chloride, in the presence of a base such as pyridine.

(A-j) A method of reacting such a hydroxyl group with a carboxylic acid having an alkenyl group, such as acrylic acid, in the presence of an acid catalyst.

In the present invention, when no halogen is directly associated with the method for introducing an alkenyl group, as in methods (A-a) and (A-b), the vinyl polymer is preferably synthesized by the living radical polymerization method. Method (A-b) is more preferable in view of easier controllability.

When an alkenyl group is introduced by converting a halogen atom of a vinyl polymer having at least one highly reactive carbon-halogen bond, a preferable polymer to be used is a vinyl polymer having at least one highly reactive carbon-halogen bond at the terminus, the vinyl polymer being obtainable by subjecting a vinyl monomer to radical polymerization (atom transfer radical polymerization method) using, as an initiator, an organic halide or a halogenated sulfonyl compound having at least one highly reactive carbon-halogen bond and, as a catalyst, a transition metal complex. Method (A-f) is more preferable in view of easier controllability.

The hydrosilane compound having a crosslinkable silyl group is not particularly limited but includes, as typical examples, compounds represented by general formula (10):
H—Si(R¹)₃₋ₐ(Y)ₐ (10)
(wherein R¹ represents an alkyl group having 1 to 20 carbon atoms, an aryl group having 6 to 20 carbon atoms, or an aralkyl group having 7 to 20 carbon atoms; Y represents a hydroxyl group or a hydrolyzable group, and when two or more Ys are present, they may be the same or different; and a represents 1, 2, or 3).

When the hydrosilane compound having a crosslinkable silyl group is added to the alkenyl group, a transition metal catalyst is generally used. Examples of the transition metal catalyst include elemental platinum; solid platinum dispersed on a carrier such as alumina, silica, or carbon black; chloroplatinic acid; complexes of chloroplatinic acid with alcohols, aldehydes, ketones, or the like; platinum-olefin complexes; and platinum (O)-divinyltetramethyldisiloxane complex. Examples of the catalyst other than platinum compounds include RhCl(PPh₃)₃, RhCl₃, RuCl₃, IrCl₃, FeCl₃, AlCl₃, PdCl₂.H₂O, NiCl₂, and TiCl₄.

The method for producing the vinyl polymer having at least one hydroxyl group, the vinyl polymer being used in methods (B) and (A-g) to (A-j), includes, but is not limited to, the following.

(B-a) A method of subjecting a compound having, in each molecule, both a polymerizable alkenyl group and a hydroxyl group to reaction as a second monomer in synthesizing the vinyl polymer by radical polymerization, for example, the compound being represented by general formula (11):
H₂C═C(R⁴)—R¹¹—R⁸—OH (11)
(wherein R⁴, R¹¹, and R⁸ represent the same as the above).

The timing when the compound having, in each molecule, both a polymerizable alkenyl group and a hydroxyl group is subjected to reaction is not limited. However, in particular, when rubber-like properties are expected in living radical polymerization, the compound is preferably subjected to reaction as a second monomer at the final stage of the polymerization reaction or after completion of the reaction of the predetermined monomer.

(B-b) A method of subjecting an alkenyl alcohol, such as 10-undecenol, 5-hexenol, or allyl alcohol, to reaction at the final stage of polymerization reaction or after completion of the reaction of the predetermined monomer in synthesizing the vinyl polymer by living radical polymerization.

(B-c) A method of subjecting a vinyl monomer to radical polymerization using a large amount of hydroxyl-group-containing chain transfer agent such as a hydroxyl-group-containing polysulfide, as described in, for example, Japanese Unexamined Patent Application Publication No. 5-262808.

(B-d) A method of subjecting a vinyl monomer to radical polymerization using hydrogen peroxide or a hydroxyl-group-containing initiator, as described in, for example, Japanese Unexamined Patent Application Publication Nos. 6-239912 and 8-283310.

(B-e) A method of subjecting a vinyl monomer to radical polymerization using an alcohol excessively, as described in, for example, Japanese Unexamined Patent Application Publication No. 6-116312.

(B-f) A method of introducing a terminal hydroxyl group by hydrolyzing a halogen atom of a vinyl polymer having at least one highly reactive carbon-halogen bond or reacting such a halogen atom with a compound having a hydroxyl group by a method described in, for example, Japanese Unexamined Patent Application Publication No. 4-132706.

(B-g) A method of reacting a vinyl polymer having at least one highly reactive carbon-halogen bond with a stabilized carbanion having a hydroxyl group to substitute the halogen, the carbanion being represented by general formula (12):
M⁺C⁻(R¹³)(R¹⁴)—R¹⁵—OH (12)
(wherein R¹³, R¹⁴, and R¹⁵ represent the same as the above).

Examples of the electron-withdrawing group R¹³ and/or R¹⁴ particularly preferably include groups having a structure of —CO₂R, —C(O)R, or —CN.

(B-h) A method of reacting a vinyl polymer having at least one highly reactive carbon-halogen bond with a metal element, such as zinc, or an organometallic compound to prepare an enolate anion, and then reacting the enolate anion with an aldehyde or a ketone.

(B-i) A method of reacting a vinyl polymer having at least one highly reactive carbon-halogen bond with an oxy anion having a hydroxyl group or carboxylate anion having a hydroxyl group to substitute the halogen, for example, the oxyanion being represented by general formula (13):
HO—R¹⁶—O⁻M⁺ (13)
(wherein R¹⁶ and M⁺ represent the same as the above), or the carboxylate anion being represented by general formula (14):
HO—R⁸—C(O)O⁻M⁺ (14)
(wherein R⁸ and M⁺ represent the same as the above)

(B-j) A method of subjecting a compound having, in each molecule, a low polymerizability alkenyl group and a hydroxyl group to reaction as a second monomer at the final stage of the polymerization reaction or after completion of the reaction of the predetermined monomer, in synthesizing the vinyl polymer by living radical polymerization.

Examples of such compound are not particularly limited but include compounds represented by general formula (15):
H₂C═C(R⁴)—R¹⁶—OH (15)
(wherein R⁴ and R¹⁶ represent the same as the above).

The compound represented by general formula (15) is not particularly limited but, in view of the ease of availability, an alkenyl alcohol such as 10-undecenol, 5-hexenol, or allyl alcohol is preferable.

In the present invention, when no halogen is directly associated with the method for introducing a hydroxyl group, as in methods (B-a) to (B-e) and (B-j), the vinyl polymer is preferably synthesized by the living radical polymerization method. Method (B-b) is more preferable in view of easier controllability.

When an hydroxyl group is introduced by converting a halogen atom of a vinyl polymer having at least one highly reactive carbon-halogen bond, a preferable polymer to be used is a vinyl polymer having at least one highly reactive carbon-halogen bond at the terminus, the vinyl polymer being obtainable by subjecting a vinyl monomer to radical polymerization (atom transfer radical polymerization method) using, as an initiator, an organic halide or a halogenated sulfonyl compound and, as a catalyst, a transition metal complex. Method (B-i) is more preferable in view of easier controllability.

Examples of the compound having, in each molecule, a crosslinkable silyl group and a group capable of reacting with a hydroxyl group, such as an isocyanato group, include γ-isocyanatopropyltrimethoxysilane, γ-isocyanatopropylmethyldimethoxysilane, and γ-isocyanatopropyltriethoxysilane. Any generally known urethanization catalyst may be used according to need.

Examples of the compound having, in each molecule, both a polymerizable alkenyl group and a crosslinkable silyl group, which is used in method (C), include γ-trimethoxysilylpropyl (meth)acrylate, and γ-methyldimethoxysilylpropyl (meth)acrylate, the compounds being represented by general formula (16):
H₂C═C(R⁴)—R¹¹—R¹⁷—Si(R¹)₃₋ₐ(Y)ₐ (16)
(wherein R¹, R⁴, R¹¹, Y, and a represent the same as the above and R¹⁷ represents a direct bond or a divalent organic group having 1 to 20 carbon atoms, which may include at least one ether bond).

The timing when the compound having, in each molecule, both a polymerizable alkenyl group and a crosslinkable silyl group is subjected to reaction is not limited. However, in particular, when rubber-like properties are expected in living radical polymerization, the compound is preferably subjected to reaction as a second monomer at the final stage of the polymerization reaction or after completion of the reaction of the predetermined monomer.

Examples of the chain transfer agent having a crosslinkable silyl group, which is used in chain transfer agent method (D), include mercaptans having a crosslinkable silyl group and hydrosilanes having a crosslinkable silyl group, as described in, for example, Japanese Examined Patent Application Publication Nos. 3-14068 and 4-55444.

Examples of the method of synthesizing the vinyl polymer having at least one highly reactive carbon-halogen bond, which is used in method (E), include, but are not limited to, the atom transfer radical polymerization method using an organic halide or the like as an initiator and a transition metal complex as a catalyst. Examples of the compound having, in each molecule, both a crosslinkable silyl group and a stabilized carbanion include compounds represented by general formula (17):
M+C⁻(R¹³)(R¹⁴)—R⁸—C(H)(R¹⁸)—CH₂—Si(R¹)₃₋ₐ(Y)ₐ (17)
(wherein R¹, R¹³, R¹⁴, Y, and a represent the same as the above, R⁸ represents a direct bond or a divalent organic group having 1 to 10 carbon atoms, which may include at least one ether bond, and R¹⁸ represents a hydrogen atom, an alkyl group having 1 to 10 carbon atoms, an aryl group having 6 to 10 carbon atoms, or an aralkyl group having 7 to 10 carbon atoms).

Examples of the electron-withdrawing group R¹³ and/or R¹⁴ particularly preferably include groups having a structure of —CO₂R, —C(O)R, or —CN.

The plasticizer (C) used in the present invention is not particularly limited and any known plasticizer may be used. Specific examples of the plasticizer include phthalate esters such as dibutyl phthalate, diheptyl phthalate, di(2-ethylhexyl) phthalate, butyl benzyl phthalate, di-n-octyl phthalate, diisononyl phthalate, diisodecyl phthalate, and diundecyl phthalate; nonaromatic dibasic acid esters such as di(2-ethylhexyl) adipate, di-n-dioctyl adipate, diisononyl adipate, diisodecyl adipate, di(2-ethylhexyl) sebacate, and di-2-ethylhexyl tetrahydrophthalate; process oil such as paraffin base oil, naphthene base oil, and aroma base oil; fatty acid oil such as linseed oil, soybean oil, and tung oil; aromatic esters such as tri-2-ethylhexyl trimellitate and triisodecyl trimellitate; fatty acid esters such as butyl oleate, methyl acetylricinoleate, and pentaerythritol ester; oligomers of polyvinyl such as polybutene, hydrogenated polybutene, hydrogenated α-olefin oligomer; oligomers of hydrogenated polybutadiene such as hydrogenated liquid polybutadiene; paraffin such as paraffin oil or chlorinated paraffin oil; cycloparaffin such as naphthene oil; aromatic oligomers such as biphenyl and triphenyl; completely or partially hydrogenated products of aromatic oligomers; sulfonic ester compounds such as alkylsulphonic phenyl ester; sulfonamide compounds such as toluenesulfonamide, N-ethyltoluenesulfonamide, and N-cyclohexyltoluenesulfonamide. These may be used alone or in combinations of two or more plasticizers.

The addition of plasticizer (C) decreases the viscosity of composition to improve the workability. Aromatic oligomers, completely or partially hydrogenated products of aromatic oligomers, sulfonic ester compounds, sulfonamide compounds, and the like are preferable because these compounds tend to significantly improve the dispersion stability of the component (A) and the component (B) in the present invention.

When the component (C) is contained, the content of component (C) is preferably 5 to 300 parts by weight, more preferably 10 to 150 parts by weight, and most preferably 30 to 120 parts by weight relative to 100 parts by weight of the component (A). If the content is less than 5 parts by weight, the effect of decreasing the viscosity of composition and the effects of improving compatibility and dispersibility of the component (A) and the component (B) may be insufficient. If the content exceeds 300 parts by weight, satisfactory mechanical properties may not be obtained.

The curable composition of the present invention may include an epoxy resin (D) according to need. The addition of epoxy resin increases the strength of the cured object, and thus the improvement in rutting resistance in the summer can be expected. Examples of the epoxy resin (D) include epichlorohydrin-bisphenol A epoxy resin, epichlorohydrin-bisphenol F epoxy resin, fire retardant epoxy resins such as glycidyl ethers of tetrabromobisphenol A; novolac epoxy resins; hydrogenated bisphenol A epoxy resins; epoxy resin of glycidyl ether of bisphenol A propylene oxide adduct; epoxy resin of glycidyl ether ester of p-hydroxybenzoic acid; m-aminophenol epoxy resin; diaminodiphenylmethane epoxy resin; urethane-modified epoxy resins; various alicyclic epoxy resins; N,N-diglycidyl aniline; N,N-diglycidyl-o-toluidine; triglycidyl isocyanurate; polyalkyleneglycol diglycidyl ether; glycidyl ethers of a polyhydric alcohol such as glycerin; hydantoin epoxy resins; and epoxy compounds of an unsaturated polymer such as petroleum resin. The epoxy resin (D) is not limited to these and any general epoxy resin may be used. Epoxy resins having at least two epoxy groups in each molecule are preferable from the view point that the reactivity during curing is high, the cured object easily forms a three-dimensional network, and the like. Bisphenol A epoxy resins and novolac epoxy resins are more preferable.

When the component (D) is added, the content of component (D) is preferably 5 to 120 parts by weight, more preferably 5 to 100 parts by weight, and most preferably 20 to 100 parts by weight relative to 100 parts by weight of the component (A). If the content exceeds 120 parts by weight, the storage stability tends to be insufficient. If the content is less than 5 parts by weight, the improvement of the strength, which is the purpose of the addition, may not be achieved.

When the epoxy resin (D) is added to the composition of the present invention, a curing agent for curing the epoxy resin may be used in combination. The usable curing agent for an epoxy resin is not particularly limited and known curing agents for epoxy resins may be used. Examples of the curing agent include, but are not limited to, primary and secondary amines such as triethylenetetramine, tetraethylenepentamine, diethylaminopropylamine, N-aminoethylpiperidine, m-xylylenediamine, m-phenylenediamine, diaminodiphenylmethane, diaminodiphenyl sulfone, isophoronediamine, and amine-terminated polyethers; tertiary amines such as 2,4,6-tris(dimethylaminomethyl)phenol and tripropylamine; salts of these tertiary amines; polyamide resins; imidazoles; dicyandiamides; boron trifluoride complex compounds; carboxylic acid anhydrides such as phthalic anhydride, hexahydrophthalic anhydride, tetrahydrophthalic anhydride, dodecynyl succinic anhydride, pyromellitic anhydride, and chlorendic anhydride; alcohols; phenols; carboxylic acids; and diketone complex compounds of aluminum or zirconium. The curing agent may be used alone or in combinations of two or more compounds.

When a curing agent for an epoxy resin is used, the amount used is preferably 0.1 to 300 parts by weight relative to 100 parts by weight of the epoxy resin.

Ketimine compounds can be used as a curing agent for an epoxy resin. Ketimine compounds are stable when no moisture is present but the ketimine compounds are decomposed by moisture into a primary amine and a ketone. The resultant primary amine functions as a room temperature curable curing agent for an epoxy resin. The use of a ketimine compound provides a one-component composition. Such a ketimine compound can be produced by condensation reaction between an amine compound and a carbonyl compound.

A known amine compound and a known carbonyl compound may be used for the synthesis of a ketimine compound. Examples of the amine compound include diamines such as ethylenediamine, propylenediamine, trimethylenediamine, tetramethylenediamine, 1,3-diaminobutane, 2,3-diaminobutane, pentamethylenediamine, 2,4-diaminopentane, hexamethylenediamine, p-phenylenediamine, and p,p′-biphenylenediamine; polyvalent amines such as 1,2,3-triaminopropane, triaminobenzene, tris(2-aminoethyl)amine, and tetra(aminomethyl)methane; polyalkylenepolyamines such as diethylenetriamine, triethylenetriamine, and tetraethylenepentamine; polyoxyalkylene-based polyamines; and aminosilanes such as γ-aminopropyltriethoxysilane, N-(β-aminoethyl)-γ-aminopropyltrimethoxysilane, and N-(β-aminoethyl)-γ-aminopropylmethyldimethoxysilane. Examples of the carbonyl compound include aldehydes such as acetaldehyde, propionaldehyde, n-butylaldehyde, isobutylaldehyde, diethylacetaldehyde, glyoxal, and benzaldehyde; cyclic ketones such as cyclopentanone, trimethylcyclopentanone, cyclohexanone, and trimethylcyclohexanone; aliphatic ketones such as acetone, methyl ethyl ketone, methyl propyl ketone, methyl isopropyl ketone, methyl isobutyl ketone, diethyl ketone, dipropyl ketone, diisopropyl ketone, dibutyl ketone, and diisobutyl ketone; and β-dicarbonyl compounds such as acetylacetone, methyl acetoacetate, ethyl acetoacetate, dimethyl malonate, diethyl malonate, methyl ethyl malonate, and dibenzoylmethane.

When a ketimine compound has an imino group, the imino group may be reacted with styrene oxide; glycidyl ethers such as butyl glycidyl ether and allyl glycidyl ether; and glycidyl esters. These ketimine compounds may be used alone or in combinations of two or more compounds. The amount of ketimine compound is 1 to 100 parts by weight relative to 100 parts by weight of the epoxy resin (D). The amount used is varied depending on the type of the epoxy resin and the type of the ketimine compound.

The curable composition of the present invention may include an alkyl (meth)acrylate polymer (E). The term “alkyl (meth)acrylate polymer (E)” represents a polymer composed of a main monomer component of an alkyl methacrylate and/or an alkyl acrylate represented by general formula (18):
CH₂═C(R¹⁹)COOR²⁰ (18)
(wherein R¹⁹ represents a hydrogen atom or a methyl group and R²⁰ represents an alkyl group having 1 to 30 carbon atoms), and the polymer may be a polymer composed of a single monomer component or a copolymer composed of a plurality of monomer components. By adding this alkyl (meth)acrylate polymer (E) to the curable composition of the present invention, the improvement of adhesiveness of the composition and the improvement of weather resistance can be expected.

Examples of R²⁰ in general formula (18) include methyl, ethyl, propyl, n-butyl, tert-butyl, 2-ethylhexyl, nonyl, lauryl, tridecyl, cetyl, stearyl, and behenyl groups. A single monomer or two or more monomers may be used as the monomer represented by general formula (18).

When two or more monomers are used, a monomer (a) having 1 to 8 carbon atoms and a monomer (b) having at least 10 carbon atoms of R²⁰ in general formula (18) are preferably used in combination. In such a case, compatibility of the curable composition can be easily controlled by changing the ratio of the monomers used.

Specific examples of the alkyl (meth)acrylate monomer include methyl (meth)acrylate, ethyl (meth)acrylate, n-propyl (meth)acrylate, n-butyl (meth)acrylate, isobutyl (meth)acrylate, tert-butyl (meth)acrylate, n-hexyl (meth)acrylate, heptyl (meth)acrylate, 2-ethylhexyl (meth)acrylate, nonyl (meth)acrylate, decyl (meth)acrylate, undecyl (meth)acrylate, lauryl (meth)acrylate, tridecyl (meth)acrylate, myristyl (meth)acrylate, cetyl (meth)acrylate, stearyl (meth)acrylate, and behenyl (meth)acrylate.

The molecular chain of the component (E) is substantially composed of at least one alkyl (meth)acrylate monomer unit. Herein, the phrase “substantially composed of the above monomer unit” means that the ratio of the alkyl (meth)acrylate monomer unit in the component (E) exceeds 50 weight percent and preferably 70 weight percent or more. The component (E) may further include a monomer unit having copolymerizability with an alkyl (meth)acrylate monomer unit, in addition to the alkyl (meth)acrylate monomer unit. For example, monomers having a carboxylic acid group, such as (meth)acrylic acid; those having an amido group, such as (meth)acrylamide and N-methylol(meth)acrylamide; those having an epoxy group, such as glycidyl (meth)acrylate; and those having an amino group, such as diethylaminoethyl (meth)acrylate and aminoethyl vinyl ether, can be expected to provide the effect of copolymerization in view of moisture curing property and inner curing property. Other examples of such a monomer unit include monomer units derived from acrylonitrile, styrene, α-methylstyrene, alkylvinyl ether, vinyl chloride, vinyl acetate, vinyl propionate, and ethylene.

Furthermore, the polymer in the component (E) may include a reactive silicon group represented by general formula (1):
—Si(R¹₃₋ₐ)Yₐ (1)
(wherein R¹ represents an alkyl group having 1 to 20 carbon atoms, an aryl group having 6 to 20 carbon atoms, an aralkyl group having 7 to 20 carbon atoms, or a triorganosiloxy group represented by (R′O)₃Si— (wherein R′ represents a monovalent hydrocarbon group having 1 to 20 carbon atoms and the three R′s may be the same or different), and when two R¹s are present, they may be the same or different; Y represents a hydroxyl group or a hydrolyzable group, and when two or more Ys are present, they may be the same or different; and a represents 1, 2, or 3).

However, when the main chain of the component (E) having the reactive silicon group represented by general formula (1) is produced by a living radical polymerization method, the component itself corresponds to the component (B). Therefore, herein, the main chain of the component (E) having the reactive silicon group represented by general formula (1) is limited to a main chain produced by a method other than the living radical polymerization method.

Examples of a method for introducing a reactive silicon group into the polymer in the component (E) include a method of copolymerizing a compound having both a polymerizable unsaturated bond and the reactive silicon group with an alkyl (meth)acrylate monomer unit. Examples of the compound having both a polymerizable unsaturated bond and a reactive silicon group include monomers represented by general formula (19) and/or general formula (20):
CH₂═C(R¹⁹) COOR²¹—Si(R¹₃₋ₐ)Yₐ (19)
(wherein R¹⁹ represents the same as the above, R²¹ represents a divalent alkylene group having 1 to 6 carbon atoms, and R¹, Y, and a represent the same as the above).
CH₂═C(R¹⁹)—Si(R¹₃₋ₐ)Yₐ (20)
(wherein R¹⁹, R¹, Y, and a represent the same as the above).

Known monomers may be used as the monomers represented by general formula (19) and/or general formula (20). Examples of the monomer include γ-methacryloxypropylpolyalkoxysilanes such as γ-methacryloxypropyltrimethoxysilane, γ-methacryloxypropylmethyldimethoxysilane, and γ-methacryloxypropyltriethoxysilane; γ-acryloxypropylpolyalkoxysilanes such as γ-acryloxypropyltrimethoxysilane, γ-acryloxypropylmethyldimethoxysilane, and γ-acryloxypropyltriethoxysilane; and vinylalkylpolyalkoxysilanes such as vinyltrimethoxysilane, vinylmethyldimethoxysilane, and vinyltriethoxysilane.

The component (E) can be produced by a normal method of vinyl polymerization, for example, a solution polymerization method with a radical reaction. The polymerization is generally performed by subjecting the above monomer, a radical initiator, and a chain transfer agent, and the like to reaction at 50° C. to 150° C. This process generally provides a polymer having a molecular weight distribution of more than 1.8.

Examples of the radical initiator include azo initiators such as 2,2′-azobisisobutyronitrile, 2,2′-azobis(2-methylbutyronitrile), 4,4′-azobis(4-cyanovaleric) acid, 1,1′-azobis(1-cyclohexanecarbonitrile), azobis(isobutyric acid amidine) hydrochloride, and 2,2′-azobis(2,4-dimethylvaleronitrile); and organic peroxide initiators such as benzoyl peroxide and ditert-butyl peroxide. From the viewpoint that, for example, the initiator is not affected by the solvent used in the polymerization and hazard for explosion or the like is low, azo initiators are preferably used.

Examples of the chain transfer agent include mercaptans such as n-dodecyl mercaptan, tert-dodecyl mercaptan, lauryl mercaptan, γ-mercaptopropyltrimethoxysilane, γ-mercaptopropylmethyldimethoxysilane, γ-mercaptopropyltriethoxysilane, and γ-mercaptopropylmethyldiethoxysilane; and halogen-containing compounds.

The polymerization may be performed in a solvent. Preferred examples of the solvent include nonreactive solvents such as ethers, hydrocarbons, and esters.

In view of the ease of handling, the component (E) preferably has a number-average molecular weight of 500 to 100,000, the number-average molecular weight being measured by GPC and determined on the polystyrene equivalent basis. More preferably, the component (E) has a number-average molecular weight of 1,500 to 30,000 because the weather resistance and the workability of the cured object are satisfactory.

When the component (E) is contained, the ratio between the component (B) and component (E), i.e., the ratio of (B)/(E) is preferably 95/5 to 10/90 by weight and more preferably 80/20 to 60/40 by weight.

With respect to the ratio of the components (B)+(E) to the component (A), the content of the components (B)+(E) is preferably 10 to 500 parts by weight, more preferably 10 to 300 parts by weight, and particularly preferably 30 to 200 parts by weight relative to 100 parts by weight of the component (A).

The tackifier (F) used in the present invention is not particularly limited and known tackifiers may be used. Specific examples of the tackifier include petroleum resins such as aliphatic petroleum resins (C-5 resins), aromatic petroleum resins (C-9 resins), mixed aliphatic and aromatic petroleum resins (C-5/C-9 resins), phenol-modified C-5/C-9 resins, and dicyclopentadiene petroleum resins; rosin ester resins, i.e., ester compounds formed with rosin acid, disproportionated rosin acid, hydrogenated rosin acid, or polymerized rosin acid and glycerin or pentaerythritol; terpene resins such as terpene resins, hydrogenated terpene resins; aromatic modified terpene resins, aromatic modified hydrogenated terpene resins, phenol-modified terpene resins (terpene phenolic resins), and alkyl phenol-modified terpene resins; styrene resins; xylene resins such as xylene resins, phenol-modified xylene resins, and alkyl phenol-modified xylene resins; phenolic resins such as novolac-type phenolic resins, resol-type phenolic resins, alkyl phenolic resins, rosin-modified phenolic resins, cashew nut oil-modified phenolic resins, and tall oil-modified phenolic resins; and modified resins produced by modifying these resins with an epoxy resin or an acrylic monomer. These may be used alone or in combinations of two or more tackifiers. In particular, various resins modified with phenol or an alkyl phenol are preferably used from the viewpoint that compatibility and dispersion stability of the component (A) and component (B) are improved.

When the component (F) is used, the amount used is preferably 3 to 50 parts by weight, more preferably 5 to 30 parts by weight, and particularly preferably 5 to 20 parts by weight relative to 100 parts by weight of the component (B).

According to need, various additives such as a silanol condensation catalyst, a filler, a thixotropic agent, and an age resister may be further added to the curable composition of the present invention.

The silanol condensation catalyst is not particularly limited and any known silanol condensation catalyst may be used. Specific examples of the silanol condensation catalyst include titanates such as tetrabutyl titanate and tetrapropyl titanate; organotin compounds such as dibutyltin dilaurate, dibutyltin maleate, dibutyltin diacetate, tin octylate, tin naphthenate, reaction products of dibutyltin oxide and a phthalate ester, and dibutyltin bis(acetylacetonate); organoaluminum compounds such as aluminum tris(acetylacetonate), aluminum tris(ethylacetoacetate), and diisopropoxy aluminum ethylacetoacetate; chelate compounds such as zirconium tetraacetylacetonate and titanium tetraacetylacetonate; lead octylate; amine compounds such as butylamine, octylamine, dibutylamine, lauryl amine, monoethanolamine, diethanolamine, triethanolamine, diethylenetriamine, triethylenetetramine, oleylamine, cyclohexylamine, benzylamine, diethylaminopropylamine, xylylenediamine, triethylenediamine, guanidine, diphenylguanidine, 2,4,6-tris(dimethylaminomethyl)phenol, morpholine, N-methylmorpholine, 2-ethyl-4-methylimidazole, and 1,8-diazabicyclo[5,4,0]undecene-7; salts of these amine compounds with carboxylic acids or the like; acidic phosphate esters; reaction products of an acidic phosphate esters and an amine; saturated or unsaturated polyvalent carboxylic acid and acid anhydrides thereof; low molecular weight polyamide resins produced from an excess polyamine and a polybasic acid; reaction products of an excess polyamine and an epoxy compound; and silane coupling agents having an amino group, for example, γ-aminopropyltrimethoxysilane and N—(β-aminoethyl)-γ-aminopropylmethyldimethoxysilane. Examples of the catalyst further include other known silanol condensation catalyst such as acidic catalysts and basic catalysts. These catalysts may be used alone or in combinations of two or more catalysts.

The amount used of silanol condensation catalyst is preferably 0.01 to 15 parts by weight and more preferably 0.1 to 10 parts by weight relative to 100 parts by weight of the component (B). If the amount is less than 0.01 parts by weight, the curability of a composition decreases. If the amount exceeds 15 parts by weight, for example, the storage stability and the adhesiveness are deteriorated. In particular, in view of the curing rate and the storage stability, tetravalent tin catalysts are preferable.

The filler is not particularly limited and any known filler may be used. Examples of the filler include inorganic fillers such as calcium carbonate, magnesium carbonate, titanium oxide, fly ash, silica sand, crushed stones, gravel, carbon black, fused silica, precipitated silica, diatomaceous earth, terra alba, kaolin, clay, talc, silicic acid anhydride, quartz powder, aluminum powder, zinc powder, asbestos, glass fiber, carbon fiber, glass beads, alumina, glass balloons, fly ash balloons, shirasu balloons, silica balloon, and silicon oxide; and organic fillers such as wood flour, walnut shell flour, chaff flour, wood fillers, e.g., pulp and cotton chips, rubber powder, fine powder of recycled rubber, fine powder of thermoplastic or thermosetting resins, and hollow particles composed of polyethylene or the like. These fillers may be used alone or in combinations of two or more fillers.

The amount of filler used is preferably 50 to 1,000 parts by weight and particularly preferably 60 to 900 parts by weight relative to 100 parts by weight of the component (B). If the amount used of the filler is less than 50 parts by weight, the purpose of using a filler may not be achieved. If the amount exceeds 1,000 parts by weight, the viscosity increases and thus the workability may be impaired. In particular, fly ash balloons and calcium carbonate are more preferable.

The thixotropic agent is not particularly limited and any known thixotropic agent may be used. Examples of the thixotropic agent include hydrogenated castor oil, organic amide wax, organic bentonite, and calcium stearate. These thixotropic agents may be used alone or in combinations of two or more thixotropic agents.

The amount of thixotropic agent used is preferably 0.1 to 50 parts by weight and particularly preferably 1 to 30 parts by weight relative to 100 parts by weight of the component (B). If the amount used of thixotropic agent is less than 0.1 parts by weight, satisfactory thixotropy may not be obtained. Also, an amount exceeding 50 parts by weight is not preferable because of the increase in the cost and the like.

The age resister is not particularly limited and any known age resister may be used. Examples of the age resister include phenolic antioxidants, aromatic amine antioxidants, sulfur-based antioxidants, phosphorus-based antioxidants, benzotriazole ultraviolet absorbers, salicylate ultraviolet absorbers, benzoate ultraviolet absorbers, benzophenone ultraviolet absorbers, hindered amine light stabilizers, and nickel-based light stabilizers.

The amount of age resister used is preferably 0.01 to 20 parts by weight and particularly preferably 0.1 to 10 parts by weight relative to 100 parts by weight of the component (B).

Examples of the phenolic antioxidant include 2,6-di-tert-butylphenol, 2,4-di-tert-butylphenol, 2,6-di-tert-butyl-4-methylphenol, 2,5-di-tert-butylhydroquinone, n-octadecyl-3-(3,5-di-tert-butyl-4-hydroxyphenyl)propionate, pentaerythrityl-tetrakis[3-(3,5-di-tert-butyl-4-hydroxyphenyl)propionate], 2,2′-methylenebis(4-methyl-6-tert-butylphenol), 4,4′-butylidenebis(3-methyl-6-tert-butylphenol), and 4,4′-thiobis(3-methyl-6-tert-butylphenol).

Examples of the aromatic amine antioxidant include N,N′-diphenyl-p-phenylenediamine and 6-ethoxy-2,2,4-trimethyl-1,2-dihydroquinoline.

Examples of the sulfur-based antioxidant include dilauryl-3,3′-thiodipropionate, ditridecyl-3,3′-thiodipropionate, and distearyl-3,3′-thiodipropionate.

Examples of the phosphorus-based antioxidant include diphenyl isooctyl phosphite and triphenyl phosphite.

Examples of the benzotriazole ultraviolet absorber include 2-(3,5-di-tert-butyl-2-hydroxyphenyl)-5-chlorobenzotriazole, 2-(3-tert-butyl-5-methyl-2-hydroxyphenyl)-5-chlorobenzotriazole, 2-(3,5-di-tert-butyl-2-hydroxyphenyl)benzotriazole, and 2-(5-methyl-2-hydroxyphenyl)benzotriazole.

Examples of the salicylate ultraviolet absorber include 4-tert-butylphenyl salicylate.

Examples of the benzoate ultraviolet absorber includes 2,4-di-tert-butylphenyl-3,5-di-tert-butyl-4-hydroxybenzoate.

Examples of the benzophenone ultraviolet absorber include 2,4-dihydroxybenzophenone, 2-hydroxy-4-methoxybenzophenone, 2-hydroxy-4-n-octoxybenzophenone, 2-hydroxy-4-n-dodecyloxybenzophenone, and 2-hydroxy-4-benzyloxybenzophenone.

Examples of the hindered amine light stabilizer includes bis(2,2,6,6-tetramethyl-4-piperidyl)sebacate, bis(1,2,2,6,6-pentamethyl-4-piperidyl)sebacate, 1-{2-[3-(3,5-di-tert-butyl-4-hydroxyphenyl)propionyloxy]ethyl}-4-[3-(3,5-di-tert-butyl-4-hydroxyphenyl)propionyloxy]-2,2,6,6-tetramethylpiperidine, and 4-benzoyloxy-2,2,6,6-tetramethylpiperidine.

Examples of the nickel-based light stabilizer includes nickel dibutyldithiocarbamate, [2,2′-thiobis(4-tert-octylphenolate)]-2-ethylhexylamine nickel (II), and [2,2′-thiobis(4-tert-octylphenolate)]-n-butylamine nickel (II).

These age resisters may be used alone or in combinations of two or more compounds. Some combinations of the age resisters may function more effectively compared with a case where a single compound is used.

The curable composition of the present invention can be used as sealing materials, adhesives, pressure-sensitive adhesives, filling materials, waterproof materials, damping materials, soundproof materials, and the like in a wide range applications to the civil engineering, the architecture, the industry, and the like.

Examples of the application include a joint sealing of interior or exterior walls, floors, various types of concrete, or metals; a sealant for vessels; a joint material for pools; an ant-proof sealant; an adhesive for floor materials, wall materials, or roofing materials; an adhesive for tiles, stones, or decorated panels on interior or exterior walls; a sealing adhesive for earthenware pipes, manholes, cables, or the like; a potting material; various pressure-sensitive adhesives; a paving material, a repairing material, and a joint material for ordinary roads, expressways, or airport runways; a waterproof material for undergrounds of buildings; a waterproof material for multistory parking garages; a waterproof material for roofs; a coating material for roofs; and a damping material and a soundproof material for vehicles, vessels, or household electric appliances.

Among these applications, the curable composition of the present invention is particularly suitable for applications to an adhesive for tiles, a waterproof material, a road-paving material, a water-stopping material for civil engineering, and a damping material. The applications to a waterproof material, an adhesive for tiles, a road-paving material, a water-stopping material for civil engineering, and a damping material will now be described.

<Waterproof Material>

A hot process for asphalt waterproofing is mainly employed for a waterproofing work. In this process, blown asphalt is melted at a construction site; thereby an application of an asphalt roofing is repeated three or four times to form a waterproofing layer. Other processes include a torch-applied process, a normal temperature (tacky adhesion) process, and an adhesion process, and the like. In the torch-applied process, the reverse face of an asphalt roofing sheet is heated with a special torch burner so that asphalt provided on the reverse face is fixed on a base material while being melted. In the normal temperature (tacky adhesion) process, asphalt is fixed on a base material with a pressure-sensitive adhesive provided on the reverse face of an asphalt roofing sheet. In the adhesion process, an asphalt roofing sheet is fixed on a base material with an asphalt-based adhesive. Among these processes, the hot process for asphalt waterproofing has been mainly employed in view of waterproofing reliability (the adhesiveness to base materials).

However, in the hot process for asphalt waterproofing, when asphalt is melted, the molten asphalt generates a large amount of fume and odor, resulting in a significant pollution of the surrounding environment. Therefore, the hot process has been avoided in thickly housed areas and central urban areas, and the area that can use the hot process has been limited. Furthermore, since workers face dangers of burn injury, they also tend to avoid the hot process.

In order to overcome these problems, before an asphalt roofing sheet is applied, cutback asphalt prepared by diluting asphalt with a solvent is used as a primer, thereby improving the adhesiveness to base materials. However, this technique significantly pollutes the environment because the solvent is volatilized.

In view of the above problems, a waterproof material including the curable composition of the present invention does not produce a fume or an odor of asphalt or a solvent odor during the working process, and exhibits satisfactory room temperature curability and satisfactory waterproof adhesiveness to mortar. Therefore, curable composition of the present invention is useful as a waterproof material, an adhesive for an asphalt roofing sheet, and a primer.

<Adhesive for Tiles>

An adhesive for tiles is used when tiles are applied on a wall of architectures or a wall of periphery of a bathroom, a rest room, or a kitchen. Examples of the adherend used in such a case include inorganic bases such as cement mortar, a calcium silicate board, a cement board, autoclaved lightweight concrete (ALC) board, and a ceramic-based siding board; wood bases such as laminated wood; and tiles composed of pottery, porcelain, or store ware.

Hitherto, a ball application process using cement mortar kneaded in the form of a ball has been mainly used for adhering tiles. However, recently, an adhesion process using an organic adhesive is used in most cases. The adhesive for tiles is broadly divided into an aqueous adhesive and a reactive adhesive. These adhesives are appropriately used according to the application. In the aqueous adhesives, since at least an aqueous emulsion containing a surface-active agent is used as a base resin, water resistance is not satisfactory. Furthermore, an odor, flammability, and adverse effects on the human body due to an organic solvent used for dissolving a tackifier, and the like are of concern. On the other hand, urethane resin-based reactive adhesives, epoxy resin-based reactive adhesives, and the like are used as typical adhesives for tiles. In the urethane resin-based adhesives, the contact dermatitis caused by an isocyanate in the system, and the hazard and adverse effects on the human body due to an organic solvent are of concern. In the epoxy resin-based adhesives, the contact dermatitis caused by an amine curing agent, and the hazard and adverse effects on the human body due to an organic solvent are of concern.

In addition, the epoxy resin-based adhesives cannot absorb a distortion when an external force is applied. Therefore, falling off of tiles caused by vibration in earthquakes or the like causes a problem. To solve these problems, Japanese Unexamined Patent Application Publication No. 6-101319 discloses that the brittleness of a cured object of an epoxy resin is improved by mixing a rubber organic polymer or a modified silicone compound to obtain a flexible cured object. However, in places where designed materials, such as tiles or stones, are frequently exposed to water, these materials may be fallen off and thus the waterproof adhesiveness is not always satisfactory.

In view of the above problems, an adhesive for tiles including the curable composition of the present invention exhibits excellent waterproof adhesiveness, in particular alkaline waterproof adhesiveness, and can be used even without solvent. Accordingly, the adhesive for tiles including the curable composition of the present invention does not bring a concern about an odor, flammability, or adverse effects on the human body.

<Road-Paving Material>

Hitherto, when asphalt is used for a road-paving material, a heating asphalt paving is generally employed. However, the heated asphalt generates a large amount of fume and odor, resulting in a significant pollution of the peripheral environment. Furthermore, in the heating asphalt paving, satisfactory elasticity and adhesiveness cannot be obtained. Consequently, as the temperature increases in the summer, the paved road surface is fluidized, thereby causing a problem of cracking or surface tackiness. Furthermore, in the winter, since the caking power of an aggregate in an asphalt paving material is decreased, the surface layer of the asphalt paving is degraded. In addition, the surface layer is cracked or separated because of the temperature difference.

In view of these problems, by using the road-paving material including the curable composition of the present invention, roads can be paved and repaired without producing a fume or an odor during paving.

When the curable composition of the present invention is used as a road-paving material, an aggregate is preferably mixed in order to improve reinforcing property.

The aggregate includes a coarse aggregate, a fine aggregate, a filler, and the like used in asphalt paving. Crushed stones are used as the coarse aggregate but cobble stones, gravel, slag, and the like may also be used. Sand such as river sand, sea sand, or mountain sand is used as the fine aggregate but iron sand and screenings of crushed stones may also be used. In addition, a light-colored aggregate and a hard aggregate may be used. Stone dust formed by pulverizing limestone or igneous rocks is used as the filler. Alternatively, other rock dust, carbonated lime powder, lime, gypsum, fly ash, fly ash balloons, cement, incinerated ash, and the like may also be used. In addition, carbon black, a pigment, and the like may also be used. Furthermore, short fibers such as asbestos, glass fiber, rock wool, a synthetic fiber, and a carbon fiber; and mica powder may be used as a part of the filler.

<Water-Stopping Material for Civil Engineering>

In the fields of civil engineering and construction, vessels, automobiles, and the like, various sealing materials are used to fill or seal jointed portions or cracked portions for the purpose of water-tightness and air-tightness. From the view point of weather resistance, curability, and workability, sealing materials including an organic polymer having a reactive silicon group are widely used as disclosed in, for example, Japanese Unexamined Patent Application Publication No. 8-003537. However, the organic polymer used in the sealing material does not have sufficient water resistance. Accordingly, for example, when the sealing material is immersed in water for a long period of time, moisture permeation, the decrease in adhesiveness on the interface, and the like occur. As a result, satisfactory water-stopping property and adhesiveness cannot be achieved. Furthermore, weather resistance of the sealing material is also unsatisfactory. Accordingly, for example, when the sealing material is exposed in the open air for a long period of time, cracks and the like are generated on the surface or inside of the sealing material. As a result, satisfactory water-stopping property and adhesiveness cannot be ensured.

In view of these problems, the water-stopping material for civil engineering including the curable composition of the present invention is excellent in weather resistance, water resistance, and adhesiveness.

<Damping Material>

Damping materials are used in vehicles, architectures, household electric appliances, and the like.

Damping materials are applied directly or indirectly on a vibration source and a soundproof function is achieved by controlling the vibration. For example, a damping material is used in steel plate parts of automobiles such as a dash panel separating an engine room and a vehicle cabin, a floor, a trunk room, and the like; architectures such as a floor of apartments; and household electric appliances generating an undesired sound, such as air conditioners, compressors, vacuum cleaners, and the like.

However, when asphalt is laminated on a floor face or the like of an automobile as a damping sheet, the asphalt must be heat-melted. As a result, a problem regarding thermal fluidity occurs. In other words, it is difficult to maintain the thickness of the sheet to be uniform. Consequently, the effect of damping is varied. In addition, the sheet cannot be satisfactorily fitted with irregular parts of the substrate and a thermal bonding is difficult to be achieved in which the sheet is uniformly contacted with the substrate. In order to overcome these technical problems, for example, Japanese Unexamined Patent Application Publication No. 7-323791 discloses a method of mixing a fibrous filler with a sheet base material. However, such a method does not satisfy these physical properties in view of the thermal bonding of asphalt. Also, in order to improve the efficiency of the working process and to improve the adhesiveness to irregular parts, a cold-setting material is desired.

In view of these problems, the damping material including the curable composition of the present invention has a satisfactory workability, does not generate blisters during application, and has excellent adhesiveness to irregular parts.

### EXAMPLES

Specific examples will now be described to further clarify the present invention, but the present invention is not limited to these examples.

### Synthesis Example 1

In a 1-L flask, copper (I) bromide (2.84 g, 19.8 mmol) and acetonitrile (39 mL) were charged and were then stirred under heating in a nitrogen stream at 70° C. for 20 minutes. Diethyl 2,5-dibromoadipate (5.93 g, 16.5 mmol), butyl acrylate (280 mL, 1.95 mol), methyl acrylate (49 mL, 0.53 mol), and stearyl acrylate (54 mL, 0.16 mol) were added and the mixture was further stirred at 80° C. for 20 minutes. Pentamethyldiethylenetriamine (hereinafter referred to as triamine) (0.41 mL, 1.98 mmol) was added to the mixture to initiate the reaction. Triamine (0.14 mL, 0.66 mmol) was further added to the mixture. Triamine (0.14 mL, 0.66 mmol) was further added while the mixture was stirred under heating at 80° C. After 180 minutes from the initiation of the reaction, the pressure in the reactor was reduced to remove the volatile matter. After 240 minutes from the initiation of the reaction, acetonitrile (118 mL), 1,7-octadiene (49 mL, 0.33 mol), and triamine (1.38 mL, 6.59 mmol) were added, and the mixture was stirred under heating at 80° C. After 620 minutes from the initiation of the reaction, the heating was stopped. The reaction solution was heated under reduced pressure to remove the volatile matter. Subsequently, the product was diluted with toluene and filtered. The filtrate was concentrated to obtain a polymer. The resultant polymer, Kyoword 500SH (manufactured by Kyowa Chemical Industry Co., Ltd.: 2 parts by weight relative to 100 parts by weight of the polymer), and Kyoword 700SL (manufactured by Kyowa Chemical Industry Co., Ltd.: 2 parts by weight relative to 100 parts by weight of the polymer) were mixed in xylene (100 parts by weight relative to 100 parts by weight of the polymer), and the mixture was stirred at 130° C. Three hours later, aluminum silicate was filtered and volatile matter in the filtrate was distilled off by heating under reduced pressure. The polymer was subjected to devolatilization by heating at 180° C. for 12 hours (the degree of vacuum: 10 Torr or less), thereby eliminating a Br group from the polymer. The polymer, Kyoword 500SH (manufactured by Kyowa Chemical Industry Co., Ltd.: 3 parts by weight relative to 100 parts by weight of the polymer), and Kyoword 700SL (manufactured by Kyowa Chemical Industry Co., Ltd.: 3 parts by weight relative to 100 parts by weight of the polymer) were mixed in xylene (100 parts by weight relative to 100 parts by weight of the polymer), and the mixture was stirred at 130° C. Five hours later, aluminum silicate was filtered and volatile matter in the filtrate was distilled off by heating under reduced pressure to prepare an alkenyl-terminated polymer A-1.

According to a GPC measurement, the number-average molecular weight of the polymer was 29,000 (on the polystyrene equivalent basis) and the molecular weight distribution was 1.3. The alkenyl group was introduced into 95% of the oligomer molecules on the average according to a ¹H-NMR analysis.

Subsequently, in a 200-mL pressure-resistant glass reactor, the above polymer (23.3 g), dimethoxymethylhydrosilane (2.55 mL, 20.7 mmol), dimethyl orthoformate (0.38 mL, 3.45 mmol), and a platinum catalyst were charged. The platinum catalyst was used in a molar ratio of 2×10⁻⁴ equivalents relative to the alkenyl group in the polymer. The reaction mixture was heated at 100° C. for 3 hours. The volatile matter was distilled off from the mixture under reduced pressure to obtain a silyl-terminated poly(n-butyl acrylate/methyl acrylate/stearyl acrylate) copolymer (Polymer A).

### Synthesis Example 2

In a 1-L flask, copper (I) bromide (2.84 g, 19.8 mmol) and acetonitrile (39 mL) were charged and were then stirred under heating in a nitrogen stream at 70° C. for 20 minutes. Diethyl 2,5-dibromoadipate (5.93 g, 16.5 mmol), butyl acrylate (254 mL, 1.77 mol), ethyl acrylate (61 mL, 0.66 mol), and stearyl acrylate (71 mL, 0.21 mol) were added and the mixture was further stirred at 80° C. for 20 minutes. Pentamethyldiethylenetriamine (hereinafter referred to as triamine) (0.41 mL, 1.98 mmol) was added to the mixture to initiate the reaction. Triamine (0.14 mL, 0.66 mmol) was further added to the mixture. Triamine (0.14 mL, 0.66 mmol) was further added while the mixture was stirred under heating at 80° C. After 180 minutes from the initiation of the reaction, the pressure in the reactor was reduced to remove the volatile matter. After 240 minutes from the initiation of the reaction, acetonitrile (118 mL), 1,7-octadiene (49 mL, 0.33 mol), and triamine (1.38 mL, 6.59 mmol) were added, and the mixture was stirred under heating at 80° C. After 620 minutes from the initiation of the reaction, the heating was stopped. The reaction solution was heated under reduced pressure to remove the volatile matter. Subsequently, the product was diluted with toluene and filtered. The filtrate was concentrated to obtain a polymer. The resultant polymer, Kyoword 500SH (manufactured by Kyowa Chemical Industry Co., Ltd.: 2 parts by weight relative to 100 parts by weight of the polymer), and Kyoword 700SL (manufactured by Kyowa Chemical Industry Co., Ltd.: 2 parts by weight relative to 100 parts by weight of the polymer) were mixed in xylene (100 parts by weight relative to 100 parts by weight of the polymer), and the mixture was stirred at 130° C. Three hours later, aluminum silicate was filtered and volatile matter in the filtrate was distilled off by heating under reduced pressure. The polymer was subjected to devolatilization by heating at 180° C. for 12 hours (the degree of vacuum: 10 Torr or less), thereby eliminating a Br group from the polymer. The polymer, Kyoword 500SH (manufactured by Kyowa Chemical Industry Co., Ltd.: 3 parts by weight relative to 100 parts by weight of the polymer), and Kyoword 700SL (manufactured by Kyowa Chemical Industry Co., Ltd.: 3 parts by weight relative to 100 parts by weight of the polymer) were mixed in xylene (100 parts by weight relative to 100 parts by weight of the polymer), and the mixture was stirred at 130° C. Five hours later, aluminum silicate was filtered and volatile matter in the filtrate was distilled off by heating under reduced pressure to prepare an alkenyl-terminated polymer B-1.

According to a GPC measurement, the number-average molecular weight of the polymer was 27,000 (on the polystyrene equivalent basis) and the molecular weight distribution was 1.3. The alkenyl group was introduced into 95% of the oligomer molecules on the average according to a ¹H-NMR analysis.

Subsequently, in a 200-mL pressure-resistant glass reactor, the above polymer (23.3 g), dimethoxymethylhydrosilane (2.55 mL, 20.7 mmol), dimethyl orthoformate (0.38 mL, 3.45 mmol), and a platinum catalyst were charged. The platinum catalyst was used in a molar ratio of 2×10⁻⁴ equivalents relative to the alkenyl group in the polymer. The reaction mixture was heated at 100° C. for 3 hours. The volatile matter was distilled off from the mixture under reduced pressure to obtain a silyl-terminated poly(n-butyl acrylate/ethyl acrylate/stearyl acrylate) copolymer (Polymer B).

### Synthesis Example 3

Polymerization of propylene oxide was performed using a 1/1 mixture weight basis of polyoxypropylene diol having a number-average molecular weight of 2,000 and polyoxypropylene triol having a number-average molecular weight of 3,000 as an initiator and a zinc hexacyanocobaltate-glyme complex catalyst to prepare polypropylene oxide having a number-average molecular weight of 22,000 (determined on the polystyrene equivalent basis by GPC). The resultant polypropylene oxide was reacted with sodium methoxide, and the product was then reacted with allyl chloride to convert the terminal hydroxyl group to an unsaturated group. Dimethoxymethylsilane (0.72 mol) was reacted with the unsaturated group (1 mol) of the unsaturated group-terminated polyoxyalkylene in the presence of chloroplatinic acid. Thus, a polyoxypropylene-based polymer (Polymer C) having a dimethoxymethylsilyl group at 70% of the molecular termini (by ¹H-NMR analysis) and a number-average molecular weight of 22,200 was obtained.

### Synthesis Example 4

Polymerization of propylene oxide was performed using polyoxypropylene diol having a number-average molecular weight of 2,000 as an initiator and a zinc hexacyanocobaltate-glyme complex catalyst to prepare polyoxypropylene glycol having a number-average molecular weight of 26,000 (determined on the polystyrene equivalent basis by GPC). The resultant polyoxypropylene glycol was reacted with sodium methoxide, and the product was then reacted with allyl chloride to convert the terminal hydroxyl group to an unsaturated group. A hydrosilane compound represented by HSi(CH₃) (CH₃)OSi(CH₃) (CH₃)CH₂CH₂Si(OCH₃)₃ (0.77 mol) was reacted with the unsaturated group (1 mol) of the unsaturated group-terminated polyoxyalkylene polymer in the presence of chloroplatinic acid. Thus, a polyoxypropylene-based polymer (Polymer D) having a trimethoxysilyl group at 75% of the molecular termini and a number-average molecular weight of 26,300 was obtained.

### Synthesis Example 5

Polyoxypropylene glycol (800 g) having a number-average molecular weight of 5,200 and isophorone diisocyanate (50.2 g) were charged in a pressure-resistant reactor equipped with a stirrer and mixed. Subsequently, a tin catalyst (a 10% DOP solution of dibutyltin dilaurate) (0.8 g) was added to the mixture. The mixture was stirred at 80° C. for 4 hours to prepare an isocyanato-terminated polymer having a number-average molecular weight of 15,000 (calculated from a titer (0.579%) of the isocyanato group). The polymer was cooled to 60° C. Subsequently, γ-aminopropyltrimethoxysilane (1.0 equivalent/NCO group) was added and the mixture was stirred for about 30 minutes. Thus, a polyoxypropylene-based polymer (Polymer E) having trimethoxysilyl groups at the molecular termini and a number-average molecular weight of 17,000 (determined on the polystyrene equivalent basis by GPC) was obtained.

Various materials used in the following examples will be described below.

Component (A)

Straight asphalt: Straight asphalt 150 to 200 (manufactured by Cosmo Oil Co., Ltd.)

Blown asphalt: Blown asphalt 20 to 30 (manufactured by Cosmo Oil Co., Ltd.)

Cutback asphalt: Asphalt prepared by diluting blown asphalt 20 to 30 with toluene (solid content: 60%)

Component (B)

Polymer A and Polymer B obtained by the above synthesis

Component (C)

Mesamoll II: Alkylsulphonic phenyl ester (manufactured by Bayer)

HB-40: Partially hydrogenated terphenyl (manufactured by Solutia, Inc.)

DIDP: Diisodecyl phthalate (manufactured by New Japan Chemical Co., Ltd.)

Topcizer No. 3: N-Ethyl-o/p-toluenesulfonamide (manufactured by Fuji Amide Chemical Co., Ltd.)

Component (D)

Epikote 828: Epoxy resin (manufactured by Japan Epoxy Resins Co., Ltd.)

Component (F)

PM-100: Phenol-modified C-5/C-9 petroleum resin (manufactured by Toho Chemical Industry Co., Ltd.)

HP-70: Alkyl phenol-modified xylene resin (manufactured by Fudow Corporation)

YS Polyster T-30: Phenol-modified terpene resin (manufactured by Yasuhara Chemical Co., Ltd.)

Mightyace G-125: Phenol-modified terpene resin (manufactured by Yasuhara Chemical Co., Ltd.)

(Block Copolymer)

SBS: Styrene-butadiene-styrene block copolymer

(Rubber Component)

SBR: Styrene-butadiene rubber

(Silane Coupling Agent)

A-171: Vinyltrimethoxysilane (manufactured by Dow Corning Toray Co., Ltd.)

A-187: γ-Glycidoxypropyltrimethoxysilane (manufactured by Dow Corning Toray Co., Ltd.)

A-1120: N-(β-Aminoethyl)-γ-aminopropyltrimethoxysilane (manufactured by Dow Corning Toray Co., Ltd.)

(Filler)

Whiton SB (calcium carbonate, manufactured by Shiraishi Calcium Kaisha, Ltd.)

Fly ash balloon: Fine hollow spherical particles (alumina silicate, manufactured by Tokai Kogyo Co., Ltd.)

Sepiolite S: Magnesium silicate (manufactured by Nippon Talc Co., Ltd.)

Silica sand: (manufactured by Maruo Calcium Co., Ltd.)

Talc: Microace P4 (average particle diameter: 4.5 μm, manufactured by Nippon Talc Co., Ltd.)

Aggregate

(Curing Catalyst)

SCAT-1: Organotin compound (manufactured by Sankyo Organic Chemicals Co., Ltd.)

(Curing Agent for Epoxy Resin)

H-30: Ketimine curing agent (manufactured by Japan Epoxy Resins Co., Ltd.)

(Antioxidant)

Irganox 245: Hindered phenol antioxidant (manufactured by Ciba Specialty Chemicals)

(Ultraviolet Absorber)

Tinuvin 213: Benzotriazole ultraviolet absorber (manufactured by Ciba Specialty Chemicals)

(Light Stabilizer)

Sanol LS765: Hindered amine light stabilizer (Sankyo Co., Ltd.)

(Evaluations of Physical Properties)

The following items were evaluated.

<Odor>

During the application of a composition, the generations of a solvent odor, an asphalt fume, and an asphalt odor were evaluated. When neither an odor nor a fume was generated, the result was represented by “Good” in the tables below. When at least one of an odor and a fume was generated, the result was represented by “Not good” in the tables below.

<Curability>

After a composition was applied, the surface of the composition was touched with a spatula at a predetermined time interval to measure the time required until the composition was not adhered to the spatula (at 23° C. and 50% R.H.). When the surface was cured within 30 minutes, the result was represented by “Good” in the tables below. When the surface was not cured within 30 minutes, the result was represented by “Not good” in the tables below.

<Storage Stability>

After the curable composition was hermetically sealed and left to stand at 50° C. for 30 days, the state of separation was evaluated. When the separation was not observed, the result was represented by “Good” in the tables below. When the separation was observed, the result was represented by “Not good” in the tables below.

<Waterproof Adhesiveness>

A composition was applied on a mortar substrate in a bead shape and aged at 23° C. and 50% R.H. for 7 days. Subsequently, the substrate was immersed in water at 23° C. for 7 days. Immediately after the substrate was taken out from the water, a cut was made between the cured object and the mortar with a knife to peel off the cured object. The state of adhesion was then observed. When the adhesive remained on the mortar side, the result was represented by “Good” in the tables below. When the adhesive did not remain on the mortar side, the result was represented by “Not good” in the tables below.

Mortar: 50×50×15 mm (manufactured by Engineering Test Service Co., Ltd.)<

<Weather Resistance Test>

The curable composition was formed into a sheet having a thickness of 3 mm. The sheet was left to stand at 23° C. for 3 days and was then heated at 50° C. for 4 days, thus preparing a rubber sheet. The rubber sheet on an aluminum plate having a thickness of 1 mm was placed in a sunshine weatherometer (manufactured by Suga Test Instruments Co., Ltd.) and the weather resistance was evaluated. When degradation was not observed under the sunshine for 5,000 hours, the result was represented by “Good” in the table below. When degradation was observed under the sunshine until 5,000 hours, the result was represented by “Not good” in the table below.

<Workability>

The viscosity of a composition was measured with a BH-type viscometer (rotor: No. 7, rotational speed: 10 rpm, temperature: 23° C.). When the viscosity was less than 500 Pa·s, the result was represented by “Good” in the tables below. When the viscosity was 500 Pa·s or more, the result was represented by “Not good” in the tables below.

<Adhesion Test of Tile>

An adhesive was uniformly applied on a mortar substrate having dimensions of 70×70×20 mm with a comb trowel. Subsequently, a porcelain tile having dimensions of 45×45×7 mm was bonded to the substrate and the resulting test piece was left to stand for 7 days (at 23° C. and 50% R.H.). A jig for a tensile test was attached on the surface of the tile of the test piece with an epoxy adhesive. The tensile test was then performed with an Autograph (speed of testing: 5 mm/min). In addition, the test piece was immersed in hot water at 60° C. or a saturated aqueous solution of calcium hydroxide at 60° C. for 7 days. Immediately after the test piece was taken out from the water or the saturated solution, the tensile test was performed to determine the waterproof adhesive strength. The ratio of the adhesive strength after the immersion in the hot water at 60° C. to the adhesive strength in the original state was calculated as a waterproof retention. The ratio of the adhesive strength after the immersion in the saturated aqueous solution of calcium hydroxide at 60° C. to the adhesive strength in the original state was calculated as an alkali-proof retention.

### Examples 1 to 8 and Comparative Examples 1 and 2

Various compounding components were kneaded with a 5-L mixer in the composition shown in Table 1 to prepare curable compositions of Examples 1 to 8 and Comparative Examples 1 and 2.

Table 1 shows the evaluation results.

TABLE 1

| | | | | | | | | | | Comparative | Comparative |
|---|---|---|---|---|---|---|---|---|---|---|---|
| | | Example 1 | Example 2 | Example 3 | Example 4 | Example 5 | Example 6 | Example 7 | Example 8 | Example 1 | Example 2 |
| Component | Straight | 70 | 50 | 70 | 70 | 70 | 70 | 70 | 70 | | |
| (A) | asphalt | | | | | | | | | | |
| | Blown | | | | | | | | | 100 | |
| | asphalt | | | | | | | | | | |
| | Cutback | | | | | | | | | | 100 |
| | asphalt | | | | | | | | | | |
| Component | Polymer A | 50 | 50 | | 50 | 50 | 50 | 50 | 50 | | |
| (B) | Polymer B | | | 50 | | | | | | | |
| Block | SBS | | | | | | | | | 10 | 10 |
| copolymer | | | | | | | | | | | |
| Component | Mesamoll | 40 | 40 | 50 | | | | | 40 | | |
| (C) | II | | | | | | | | | | |
| | HB-40 | 10 | 10 | 20 | | | | | 10 | | |
| | DIDP | | | | | 40 | 40 | 40 | | | |
| | Topcizer | | | | 40 | | | | | | |
| | No. 3 | | | | | | | | | | |
| Component | PM-100 | 5 | 5 | 5 | 5 | | | | | | |
| (F) | HP-70 | | | | | 10 | | | | | |
| | T-30 | | | | | | 10 | | 5 | | |
| | G-125 | | | | | | | 10 | | | |
| Silane | A-171 | 1 | 1 | 1 | 1 | 1 | 1 | 1 | 1 | | |
| coupling | A-1120 | 3 | 3 | 3 | 3 | 3 | 3 | 3 | 3 | | |
| agent | | | | | | | | | | | |
| Filler | Whiton | 100 | 70 | 150 | 100 | 100 | 100 | 100 | 100 | 100 | 100 |
| | SB | | | | | | | | | | |
| | Fly ash | 50 | 90 | | 50 | 50 | 50 | 50 | 50 | 50 | 50 |
| | balloon | | | | | | | | | | |
| Curing | SCAT-1 | 1 | 1 | 1 | 1 | 1 | 1 | 1 | 1 | | |
| catalyst | | | | | | | | | | | |
| Odor | | Good | Good | Good | Good | Good | Good | Good | Good | Not good | Not good |
| Curability | | Good | Good | Good | Good | Good | Good | Good | Good | Good | Not good |
| Storage | | Good | Good | Good | Good | Good | Good | Good | Good | Not good | Good |
| stability | | | | | | | | | | | |
| Waterproof | | Good | Good | Good | Good | Good | Good | Good | Good | Not good | Not good |
| adhesiveness | | | | | | | | | | | |

The curable compositions in the examples did not generate a fume or an odor of asphalt or a solvent odor during the working process, and exhibited satisfactory room temperature curability and satisfactory waterproof adhesiveness to mortar. The level of storage stability was also satisfactory. In contrast, no system in the comparative examples had satisfactorily balanced these characteristics.

### Examples 9 and 10 and Comparative Examples 3 to 6

Comparison of Performance as Adhesive for Tile

Various compounding components were kneaded with a 5-L mixer in the composition shown in Table 2 to prepare adhesives of Examples 9 and 10 and Comparative Examples 3 to 6.

Table 2 shows the evaluation results.

TABLE 2

| | | | Example | Comparative | Comparative | Comparative | Comparative |
|---|---|---|---|---|---|---|---|
| | | Example 9 | 10 | Example 3 | Example 4 | Example 5 | Example 6 |
| Component (A) | Straight asphalt | 50 | 50 | | | | |
| Component (B) | Polymer A | 100 | | 100 | | | |
| | Polymer B | | 100 | | | | |
| | Polymer C | | | | 100 | | |
| | Polymer D | | | | | 100 | |
| | Polymer E | | | | | | 100 |
| Component (C) | Mesamoll II | 40 | 40 | 70 | 40 | 20 | 20 |
| | HB-40 | | | | | 20 | 20 |
| Component (D) | Epikote 828 | 10 | 10 | 10 | 10 | 10 | 10 |
| Component (F) | Petroleum resin | 10 | 10 | | | | |
| | PM-100 | | | | | | |
| Silane coupling | A-171 | 1 | 1 | 1 | 1 | 1 | 1 |
| agent | A-187 | 3 | 3 | 3 | 3 | 3 | 3 |
| Filler | Whiton SB | 200 | 200 | 200 | 200 | 200 | 200 |
| | Sepiolite S | 5 | 5 | 5 | 5 | 5 | 5 |
| | Silica sand | 50 | 50 | 50 | 100 | 100 | 100 |
| Curing catalyst | SCAT-1 | 1 | 1 | 1 | 1 | 1 | 1 |
| Curing agent | Epikure H-30 | 5 | 5 | 5 | 5 | 5 | 5 |
| for epoxy resin | | | | | | | |
| Adhesive | Original state (MPa) | 1.2 | 1.3 | 1.3 | 1.4 | 1.5 | 1.3 |
| strength of | After immersing in | 1.0 | 1.1 | 0.8 | 0.9 | 1.0 | 0.8 |
| tile | water (MPa) | | | | | | |
| | After immersing in | 0.9 | 0.9 | 0.5 | 0.6 | 0.7 | 0.6 |
| | alkali (MPa) | | | | | | |
| | Waterproof retention | 83 | 84 | 62 | 64 | 67 | 62 |
| | (%) | | | | | | |
| | Alkali-proof | 75 | 71 | 41 | 43 | 47 | 46 |
| | retention (%) | | | | | | |

The adhesives in the examples exhibited satisfactory adhesive strength in the original state, after being immersed in water, and after being immersed in an aqueous solution of calcium hydroxide, and thus had satisfactory adhesiveness and durability. In contrast, although the adhesives in the comparative examples exhibited satisfactory adhesive strength in the original state, the adhesive strength was drastically decreased after the adhesives were immersed in water.

### Examples 11 and 12 and Comparative Examples 7 to 9

Comparison of Performance as Waterproof Material

Various compounding components were kneaded with a 5-L mixer in the composition shown in Table 3 to prepare waterproof materials of Examples 11 and 12 and Comparative Examples 7 to 9.

Table 3 shows the evaluation results.

TABLE 3

| | | Example | Example | Comparative | Comparative | Comparative |
|---|---|---|---|---|---|---|
| | | 11 | 12 | Example 7 | Example 8 | Example 9 |
| Component | Straight | 70 | 70 | 20 | | |
| (A) | asphalt | | | | | |
| | Blown | | | 80 | 100 | |
| | asphalt | | | | | |
| | Cutback | | | | | 100 |
| | asphalt | | | | | |
| Component | Polymer A | 50 | | | | |
| (B) | Polymer B | | 50 | | | |
| Block | SBS | | | 10 | 10 | 10 |
| copolymer | | | | | | |
| Component | Mesamoll | 40 | 40 | | | |
| (C) | II | | | | | |
| Component | PM-100 | 5 | 5 | | | |
| (F) | | | | | | |
| Silane | A-171 | 1 | 1 | | | |
| coupling | A-1120 | 2 | 2 | | | |
| agent | | | | | | |
| Filler | Whiton | 100 | 70 | 200 | 200 | 200 |
| | SB | | | | | |
| | Fly ash | 50 | 90 | | | |
| | balloon | | | | | |
| Curing | SCAT-1 | 1 | 1 | | | |
| catalyst | | | | | | |
| Workability | | Good | Good | Not good | Not good | Not good |
| Odor | | Good | Good | Not good | Not good | Not good |
| Curability | | Good | Good | Good | Good | Not good |
| Storage | | Good | Good | Not good | Not good | Good |
| stability | | | | | | |

The waterproof material compositions in the examples did not generate a fume or an odor of asphalt or a solvent odor during the working process, had a low viscosity to provide satisfactory workability, and exhibited satisfactory room temperature curability. The level of storage stability was also satisfactory. In contrast, no system in the comparative examples had satisfactorily balanced these characteristics.

### Examples 13 and 14 and Comparative Examples 10 to 13

Comparison of Performance as Sealing Material Composition

Various compounding components were kneaded with a 5-L mixer in the composition shown in Table 4 to prepare sealing material compositions of Examples 13 and 14 and Comparative Examples 10 to 13.

Table 4 shows the evaluation results.

TABLE 4

| | | Example | Example | Comparative | Comparative | Comparative | Comparative |
|---|---|---|---|---|---|---|---|
| | | 13 | 14 | Example 10 | Example 11 | Example 12 | Example 13 |
| Component (A) | Straight asphalt | 50 | 50 | | | | |
| Component (B) | Polymer A | 100 | | 100 | | | |
| | Polymer B | | 100 | | | | |
| | Polymer C | | | | 100 | | |
| | Polymer D | | | | | 100 | |
| | Polymer E | | | | | | 100 |
| Component (C) | Mesamoll II | 40 | 40 | 90 | 40 | 20 | 20 |
| | HB-40 | | | | | 20 | 20 |
| Component (F) | PM-100 | 10 | 10 | | | | |
| Silane coupling | A-171 | 1 | 1 | 1 | 1 | 1 | 1 |
| agent | A-1120 | 2 | 2 | 2 | 2 | 2 | 2 |
| Filler | Whiton SB | 200 | 200 | 200 | 200 | 200 | 200 |
| Antioxidant | Irganox 245 | 1 | 1 | 1 | 1 | 1 | 1 |
| Ultraviolet | Tinuvin 213 | 1 | 1 | 1 | 1 | 1 | 1 |
| absorber | | | | | | | |
| Light | Sanol LS765 | 1 | 1 | 1 | 1 | 1 | 1 |
| stabilizer | | | | | | | |
| Curing catalyst | SCAT-1 | 1 | 1 | 1 | 1 | 1 | 1 |
| Weather | | Good | Good | Not good | Not good | Not good | Not good |
| resistance | | | | | | | |
| Waterproof | | Good | Good | Not good | Not good | Not good | Not good |
| adhesiveness | | | | | | | |

The sealing material compositions in the examples exhibited satisfactory waterproof adhesiveness and weather resistance. In contrast, all the compositions in the comparative examples showed unsatisfactory results.

### Examples 15 and 16 and Comparative Examples 14 and 15

Various compounding components were kneaded with a 5-L mixer in the composition shown in Table 5 to prepare damping materials of Examples 15 and 16 and Comparative Examples 14 and 15.

Table 5 shows the evaluation results.

TABLE 5

| | | | | Com- | Com- |
|---|---|---|---|---|---|
| | | | | parative | parative |
| | | Example | Example | Example | Example |
| | | 15 | 16 | 14 | 15 |
| Component | Straight | 70 | 70 | 100 | |
| (A) | asphalt | | | | |
| | Blown | | | | 100 |
| | asphalt | | | | |
| Component | Polymer A | 50 | | | |
| (B) | Polymer B | | 50 | | |
| Component | Mesamoll | 40 | 40 | | |
| (C) | II | | | | |
| Component | PM-100 | 5 | 5 | | |
| (F) | | | | | |
| Rubber | SBR | | | 15 | 15 |
| component | | | | | |
| Silane | A-171 | 1 | 1 | | |
| coupling | A-1120 | 2 | 2 | | |
| agent | | | | | |
| Filler | Whiton | 100 | 100 | 150 | 150 |
| | SB | | | | |
| | Fly ash | 50 | 50 | 50 | 50 |
| | balloon | | | | |
| Curing | SCAT-1 | 1 | 1 | | |
| catalyst | | | | | |
| Workability | | Good | Good | Not good | Not good |
| Odor | | Good | Good | Not good | Not good |
| Curability | | Good | Good | Good | Good |
| Storage | | Good | Good | Not good | Not good |
| stability | | | | | |

In the damping materials in the examples, since the asphalt need not be heat-melted when applied, the thermal fluidity was satisfactory. Furthermore, the damping materials in the examples had a low viscosity to provide satisfactory workability and exhibited satisfactory room temperature curability. The level of storage stability was also satisfactory.

(Blending Example of Road-Paving Material)

A blending example when the curable composition of the present invention is used as a road-paving material is described below.

| | | |
|---|---|---|
| Straight asphalt 150 to 200: | 140 | parts by weight |
| Polymer A: | 100 | parts by weight |
| Mesamoll: | 70 | parts by weight |
| PM-100: | 10 | parts by weight |
| A-171: | 2 | parts by weight |
| A-1120: | 3 | parts by weight |
| Aggregate: | 200 | parts by weight |
| SCAT-1: | 2 | parts by weight |

What is claimed is:

1. A curable composition comprising:
a bituminous substance (A); and
a vinyl polymer (B) which has a reactive silicon group represented by general formula (1):
—Si(R¹₃₋ₐ)Yₐ (1)
(wherein R¹ represents an alkyl group having 1 to 20 carbon atoms, an aryl group having 6 to 20 carbon atoms, an aralkyl group having 7 to 20 carbon atoms, or a triorganosiloxy group represented by (R′O)₃Si— (wherein R′ represents a monovalent hydrocarbon group having 1 to 20 carbon atoms and the three R′s may be the same or different), and when two R¹s are present, they may be the same or different; Y represents a hydroxyl group or a hydrolyzable group, and when two or more Ys are present, they may be the same or different; and a represents 1, 2, or 3) and whose main chain is produced by living radical polymerization.

2. The curable composition according to claim 1, wherein the main chain of the vinyl polymer (B) is produced by polymerizing mainly at least one monomer selected from the group consisting of (meth)acrylic monomers, acrylonitrile monomers, aromatic vinyl monomers, fluorine-containing vinyl monomers, and silicon-containing vinyl monomers.

3. The curable composition according to claim 1, wherein the main chain of the vinyl polymer (B) is a (meth)acrylic polymer.

4. The curable composition according to claim 1, wherein the main chain of the vinyl polymer (B) is an acrylic polymer.

5. The curable composition according to claim 4, wherein the main chain of the vinyl polymer (B) is an acrylate polymer.

6. The curable composition according to claim 1, wherein the main chain of the vinyl polymer (B) is produced by atom transfer radical polymerization.

7. The curable composition according to claim 6, wherein, in the atom transfer radical polymerization, a complex selected from transition metal complexes containing, as a central metal, an element selected from Group 7, Group 8, Group 9, Group 10, and Group 11 in the periodic table is used as a catalyst.

8. The curable composition according to claim 7, wherein the complex used as the catalyst is a complex selected from the group consisting of complexes of copper, nickel, ruthenium, or iron.

9. The curable composition according to claim 1, further comprising a plasticizer (c).

10. The curable composition according to claim 9, wherein the plasticizer (c) is an aromatic oligomer or a completely or partially hydrogenated product of an aromatic oligomer.

11. The curable composition according to claim 9, wherein the plasticizer (c) is a sulfonic ester compound or a sulfonamide compound.

12. The curable composition according to claim 1, further comprising an epoxy resin (D).

13. The curable composition according to claim 12, wherein the content of the epoxy resin (D) is 5 to 120 parts by weight relative to 100 parts by weight of the bituminous substance (A).

14. The curable composition according to claim 1, further comprising an alkyl (meth)acrylate polymer (E).

15. The curable composition according to claim 14, wherein the molecular chain of the alkyl (meth)acrylate polymer (E) comprises a copolymer including an alkyl (meth)acrylate monomer unit (a) containing an alkyl group having 1 to 8 carbon atoms and an alkyl (meth)acrylate monomer unit (b) containing an alkyl group having at least 10 carbon atoms.

16. The curable composition according to claim 1, further comprising a tackifier (F).

17. The curable composition according to claim 16, wherein the tackifier (F) is a tackifying resin modified with at least one of phenol and an alkyl phenol.

18. The curable composition according to claim 1, wherein the bituminous substance (A) comprises at least one of natural asphalt and petroleum asphalt.

19. An adhesive for tiles, comprising the curable composition according to claim 1.

20. A waterproof material comprising the curable composition according to claim 1.

21. A road-paving material comprising the curable composition according to claim 1.

22. A water-stopping material for civil engineering, the water-stopping material comprising the curable composition according to claim 1.

23. A damping material comprising the curable composition according to claim 1.
